(19) United States
(12) Patent Application Publication
(10) Pub. No.: US 2014/0179941 A1
(43) Pub. Date: Jun. 26, 2014

(54) Synthesis and Surface Functionalization of Particles

(71) Applicant: Board of Trustees of The University of Alabama, Tuscaloosa, AL (US)

(72) Inventor: Yuping Bao, Tuscaloosa, AL (US)

(73) Assignee: Board of Trustees of The University of Alabama, Tuscaloosa, AL (US)

(21) Appl. No.: 14/136,704

(22) Filed: Dec. 20, 2013

Related U.S. Application Data
(60) Provisional application No. 61/739,903, filed on Dec. 20, 2012.

(51) Int. Cl. C07F 19/00

(52) U.S. Cl. CPC C07F 19/00
USPC 554/74

(57) ABSTRACT

Provided are methods of controlling the shape and surface chemistry of nanoparticles, particularly ferrite nanoparticles. Methods for preparing non-spherical ferrite nanoparticles, including nanocubes, nanobars, nanoplates, and nanoflowers, are described. Also provided are methods of functionalizing the surface of metal and metal oxide particles. The surface functionalization methods do not require the use of chemical linkers and/or additional reagents, and permit the facile conjugation of a range of molecules, including bioactive agents, to the surface of particles.

### CROSS-REFERENCE TO RELATED APPLICATIONS

This application claims benefit of U.S. Provisional Application No. 61/739,903, filed Dec. 20, 2012, which is hereby incorporated herein by reference in its entirety.

### STATEMENT REGARDING FEDERALLY FUNDED RESEARCH

This invention was made with Government Support under Grant No. 0907204 awarded by the National Science Foundation. The Government has certain rights to the invention.

### TECHNICAL FIELD

The present disclosure is generally related to the synthesis and surface functionalization of particles, particularly magnetic ferrite nanoparticles.

### BACKGROUND

Nanoparticles (NPs) have attracted tremendous interest for diverse applications in many areas including bioimaging, diagnosis, drug delivery, photocatalysis, and electochemistry. In particular, ferrite nanoparticles have attracted interest for certain applications as a result of their desirable magnetic properties.

The physical and chemical properties of NPs—and thus their suitability for particular applications—are dependent on a number of factors, including their chemical composition, shape, and size. For example, the catalytic activity, cellular uptake, and blood circulation time of NPs are all known to be strongly shape-dependent. In the case of ferrite NPs, shape also influences the magnetic properties of the NPs. However, compared to some types of semiconductor and noble metal NPs, methods of controlling the shape of magnetic NPs (e.g., ferrite NPs) are relatively limited.

Similarly, surface functionalization offers the promise of generating NPs with the particular properties desired for many applications in fields such as nanomedicine (e.g., targeted drug delivery, bioassays, etc.). For example, NPs can be targeted to specific regions by conjugating targeting agents (e.g., antibodies) to the surface of the NPs. Bioactive agents (e.g., small molecule therapeutic agents; biomacromolecules such as proteins and polysaccharides; and diagnostic agents) can be conjugated to the surface of NPs to convey added functionality to the NPs. Small molecules, oligomers, and polymers can also be conjugated to the surface of NPs to modify their chemical and physical properties. While many methods for the surface functionalization of NPs have been explored, most existing methods suffer from significant shortcomings For example, many conjugation methods lack simplicity and/or versatility (e.g., they lack functional group tolerance, require undesirable linkers, and/or require undesirable reagents or reaction conditions).

Methods of controlling the shape and surface chemistry of nanoparticles, particularly ferrite nanoparticles, offer the potential to provide NPs with improved properties for diverse applications in nanomedicine, catalysis, analytical chemistry, and materials science.

### SUMMARY

Methods of controlling the shape and surface chemistry of particles, particularly ferrite nanoparticles, are described.

Provided herein are methods of preparing non-spherical nanoparticles, including ferrite nanocubes, nanobars, nanoplates, and nanoflowers

Non-spherical nanoparticles can be prepared by incubating a precursor complex comprising a metallic moiety and one or more ligands coordinated to the metallic moiety at a temperature of from about 100° C. to about 300° C. for a period of time effective to form a population of nuclei by thermal displacement of one or more of the ligands from the metallic moiety, and heating the nuclei at a temperature of from greater than 300° C. to 400° C. to form a population of non-spherical nanoparticles.

Also provided are a methods of preparing non-spherical nanoparticles that can comprise incubating a precursor complex comprising a metallic moiety and one or more ligands coordinated to the metallic moiety at a temperature of from about 100° C. to about 300° C. for a period of time effective to form a population of non-spherical nanoparticles by thermal displacement of one or more of the ligands from the metallic moiety, and adding a ligand mixture comprising one or more fatty acids and one or more capping ligands, wherein the molar ratio of the fatty acids to the capping ligands ranges from 2:1 to 1:10.

Also provided are methods of functionalizing the surface of metal and metal oxide particles. Methods of functionalizing the surface of a metal or metal oxide particles can involve coordinating a catecholamine to the metal or metal oxide particle surface via the amine moiety of the catecholamine, oxidizing the catechol moiety of the catecholamine to form a benzoquinone moiety, and conjugating a functional agent comprising a nucleophilic moiety to the catecholamine by reacting the benzoquinone moiety of the catecholamine with the nucleophilic moiety of the functional agent.

Using these methods, the surface of metal and metal oxide particles can be functionalized by conjugating functional agents to ligands coordinated to the particle surface. Conjugation can be accomplished without the use of chemical linkers and/or additional reagents, thus providing a convenient route for the conjugation of a range of molecules, including bioactive agents, to the surface of particles.

### BRIEF DESCRIPTION OF THE FIGURES

FIGS. 1A-1F are transmission electron microscopy (TEM) micrographs (left of each panel) and high-resolution transmission electron microscopy (HRTEM) micrographs (right of each panel) of ferrite nanocubes doped with Mg (MgFe₂O₄; FIG. 1A), Cu (CuFe₂O₄; FIG. 1B), Ca (CaFe₂O₄; FIG. 1C), Zn (ZnFe₂O₄; FIG. 1D), Fe (FeFe₂O₄; FIG. 1E), and Mn (MnFe₂O₄; FIG. 1F). The scale bar included in the TEM micrographs is 20 nm. The scale bar included in the HRTEM micrographs is 2 nm.

FIG. 2A shows XPS plots of MnFe₂O₄ nanoparticles. Panel a (left) shows the Mn 2p core-level XPS pattern of the MnFe₂O₄ nanoparticles. Panel b (right) shows the Fe 2p core-level XPS pattern of the MnFe₂O₄ nanoparticles.

FIG. 2B shows XPS plots of ZnFe₂O₄ nanoparticles. Panel a (left) shows the Zn 2p core-level XPS pattern of the ZnFe₂O₄ nanoparticles. Panel b (right) shows the Fe 2p core-level XPS pattern of the ZnFe₂O₄ nanoparticles.

FIG. 2C shows XPS plots of CaFe₂O₄ nanoparticles. Panel a (left) shows the Ca 2p core-level XPS pattern of the CaFe₂O₄ nanoparticles. Panel b (right) shows the Fe 2p core-level XPS pattern of the CaFe₂O₄ nanoparticles.

FIG. 2D shows XPS plots of CuFe₂O₄ nanoparticles. Panel a (left) shows the Cu 2p core-level XPS pattern of the CuFe₂O₄ nanoparticles. Panel b (right) shows the Fe 2p core-level XPS pattern of the CuFe₂O₄ nanoparticles.

FIG. 2E shows XPS plots of MgFe₂O₄ nanoparticles. Panel a (left) shows the Mg is core-level XPS pattern of the MgFe₂O₄ nanoparticles. Panel b (right) shows the Fe 2p core-level XPS pattern of the MgFe₂O₄ nanoparticles.

FIG. 3 is a TEM micrograph of ferrite nanobars. The scale bar included in the TEM micrograph is 50 nm.

FIGS. 4A-4B are transmission electron microscopy (TEM) micrographs (FIG. 4A) and high-resolution transmission electron microscopy (HRTEM) micrographs (FIG. 4B) of iron oxide nanoplates with a side length of ˜18 nm. The nanoplates were highly crystalline, as suggested ordered dot pattern of the fast Fourier transformation (FFT) image (FIG. 4B, inset).

FIGS. 4C-4D are transmission electron microscopy (TEM) micrographs (FIG. 4C) and high-resolution transmission electron microscopy (HRTEM) micrographs (FIG. 4D) of iron oxide nanoflowers. The nanoflowers were composed of many small (˜5 nm) iron oxide nanocrystals, as indicated by the ring dot pattern of the FFT image (FIG. 4D, inset).

FIG. 5A is a plot of the x-ray diffraction (XRD) pattern of the nanoplates shown in FIGS. 4A and 4B (top, circles) and the nanoflowers shown in FIGS. 4C and 4D (bottom, triangles).

FIG. 5B is a plot of the XPS Fe₂ₚ core-level spectra the nanoplates shown in FIGS. 4A and 4B (circles) and the nanoflowers shown in FIGS. 4C and 4D (triangles).

FIG. 5C is a plot of the XPS O₁ₛ core-level spectra the nanoplates shown in FIGS. 4A and 4B (circles) and the nanoflowers shown in FIGS. 4C and 4D (triangles).

FIG. 6 shows plost of the magnetization versus applied field (M-H curve) measured for both the nanoplates shown in FIGS. 4A and 4B (left) and the nanoflowers shown in FIGS. 4C and 4D (right).

FIG. 7A is a TEM image of dopamine-coated iron oxide nanoparticles. The nanoparticles have an average particle size of approximately 10 nm. The scale bar included in the TEM micrograph is 20 nm.

FIG. 7B shows the overlaid Fourier transform infrared spectroscopy (FTIR) spectra of free dopamine (bottom trace), dopamine-coated (middle trace), and activated dopamine-coated nanoparticles (top trace). FIG. 7C shows the time-dependent UV-vis spectra of dopamine-coated iron oxide nanoparticles after activation. UV-vis spectra were obtained 0.5 hours, 1 hour, 2 hours, and 4 hours following activation.

FIG. 8 illustrates a general strategy employed to functionalize the surface of iron oxide nanoparticles. The NP surface is coated with dopamine ligands. The dopamine ligands coordinate to the NP surface via their amine moieties; their catechol moieties remain un-coordinated, and are extended towards solution on the nanoparticle exterior. In the first step, the catechol moieties are activated by oxidation to form benzoquinone moieties. In the second step, the benzoquinone moieties can be reacted with a suitable nucleophile to covalently functionalize the surface of the nanoparticles.

FIG. 9 shows the FTIR spectrum of PEG-conjugated nanoparticles.

FIG. 10 shows the FTIR spectrum of glutathione-conjugated nanoparticles.

FIG. 11 is a plot of the zeta-potential of NPs at pH 6 before (left trace, −30 mV) and after (right trace, 22 mV) histamine conjugation.

FIG. 12 is a stained TEM micrograph of IgG antibody-conjugated iron oxide NPs. The scale bar included in the TEM micrograph is 20 nm.

FIG. 13A is a HRTEM micrograph of a BSA-coated Au nanocluster conjugated to an iron oxide nanoparticle. The scale bar included in the HRTEM micrograph is 2 nm.

FIG. 13B is a high angle annular dark field (HAADF) scanning transmission electron microscopy image of a BSA-coated Au nanoclusters conjugated to iron oxide nanoparticles. The scale bar included in the HAADF micrograph is 20 nm.

FIG. 13C is a DLS plot of the hydrodynamic size of the activated NPs before (left trace, 24 nm) and after (right trace, 39 nm) conjugation with BSA-coated Au nanoclusters.

FIG. 13D is a plot of the zeta-potential of the activated NPs before (left trace, −42 mV) and after (right trace, −37 mV) conjugation with BSA-coated Au nanoclusters.

FIG. 13E shows the Energy-dispersive X-ray spectroscopy (EDX) spectrum obtained from the Au nanocluster-NP conjugates.

FIG. 14 shows the FTIR spectrum of lysine conjugated to dopamine-coated iron oxide NPs.

FIG. 15 is a negatively-stained TEM image of antibody-conjugated iron oxide nanocubes. The small black dots present in the image are artifacts resulting from precipitation of the staining solution. The scale bar included in the TEM micrograph is 20 nm

### DETAILED DESCRIPTION

### General Definitions

“Monodisperse” and “homogeneous size distribution,” as used herein, and generally describe a population of nanoparticles where all of the nanoparticles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

“Mean particle size” or “average particle size”, are used interchangeably herein, and generally refer to the statistical mean particle size of the nanoparticles in a population of nanoparticles. The diameter of a non-spherical nanoparticle may refer preferentially to the hydrodynamic diameter. As used herein, the hydrodynamic diameter of a non-spherical nanoparticle may refer to the largest linear distance between two points on the surface of the nanoparticle. Mean particle size can be measured using methods known in the art, such as evaluation by scanning electron microscopy.

“Ferrite,” as used herein, refers to a mixed oxide with a general structure AB₂O₄ (where A and B are two different metal ions) such as, but not limited to, magnetite (Fe₃O₄), maghemite (Fe₂O₃), zinc ferrite, calcium ferrite, magnesium ferrite, manganese ferrite, copper ferrite, chromium ferrite, cobalt ferrite, nickel ferrite, sodium ferrite, potassium ferrite, and barium ferrite.

“Catechol,” as used herein, refers to 1,2-dihydroxybenzene moiety.

“Catecholamine,” as used herein, refers to an organic compound comprising a catechol moiety and a side-chain comprising an amine group. Examples of catecholamines include dopamine, L-DOPA (L-3,4-dihydroxyphenylalanine), and norepinephrine.

Provided are methods of preparing non-spherical nanoparticles.

Non-spherical nanoparticles can be prepared by incubating a precursor complex comprising a metallic moiety and one or more ligands coordinated to the metallic moiety at a temperature of from about 100° C. to about 300° C. for a period of time effective to form a population of nuclei by thermal displacement of one or more of the ligands from the metallic moiety, and heating the nuclei at a temperature of from greater than 300° C. to 400° C. to form a population of non-spherical nanoparticles.

The shape and size of the non-spherical nanoparticles formed by this method can be selected based on a number of factors, including the composition of the precursor complex (e.g., the identity and/or quantity of the ligands coordinated to the metallic moiety), the incubation conditions (e.g., incubation temperature, duration, or combinations thereof), and the heating conditions (e.g., heating temperature, duration, or combinations thereof). In some embodiments, the population of non-spherical particles formed by this method is monodisperse.

In some embodiments, the smallest dimension of the non-spherical nanoparticles prepared by this method is greater than 4 nm (e.g., greater than 5 nm, greater than 6 nm, greater than 7 nm, greater than 8 nm, greater than 9 nm, greater than 10 nm, greater than 11 nm, greater than 12 nm, greater than 13 nm, greater than 14 nm, greater than 15 nm, greater than 20 nm, greater than 25 nm, greater than 30 nm, greater than 35 nm, greater than 40 nm, or greater than 45 nm). In some cases, the smallest dimension of the non-spherical nanoparticles is about 50 nm or less (e.g., about 45 nm or less, about 40 nm or less, about 35 nm or less, about 30 nm or less, about 25 nm or less, about 20 nm or less, about 15 nm or less, or about 10 nm or less).

The smallest dimension of the non-spherical nanoparticles prepared by this method can range from any of the minimum values described above to any of the maximum values described above. For example, the smallest dimension of the non-spherical nanoparticles can range from greater than 4 nm to about 50 nm (e.g., from greater than 5 nm to about 50 nm, from greater than 4 nm to about 30 nm, from greater than 5 nm to about 30 nm, from greater than 10 nm to about 50 nm, or from greater than 10 nm to about 30 nm).

In some embodiments, the non-spherical nanoparticles formed by this method comprise nanocubes. Nanocubes are nanostructures which are essentially cubic in shape (i.e., they have approximately the same height, width, and depth dimensions, wherein no side is greater than about 1.5 times larger than another side).

In certain embodiments, the non-spherical nanoparticles comprise nanocubes having sides ranging in length from greater than 4 nm to about 50 nm (e.g., from greater than 5 nm to about 50 nm, from greater than 4 nm to about 30 nm, from greater than 5 nm to about 30 nm, from greater than 10 nm to about 50 nm, or from greater than 10 nm to about 30 nm).

In some embodiments, the non-spherical nanoparticles formed by this method comprise nanobars. Nanobars can be nanostructures which possess an elongated rectangular shape. The cross-sectional dimensions of such nanobars (i.e., the nanobar's width and thickness) can be the same or different. In certain embodiments, the nanobars can be nanorods. Nanorods are nanostructures have an elongated spherical or cylindrical shape (e.g., the shape of a pill). Nanorods possess a circular, elliptical, or ovular cross-section, such that the width of the nanorods is equal to, for example, the diameter of the nanorod.

Nanobars can be defined by their aspect ratio, defined as the length of the nanobar divided by the width of the nanobar. Nanobars have an aspect ratio of at least about 1.5 (e.g., at least about 1.75, at least about 2.0, at least about 2.25, at least about 2.5, at least about 2.75, at least about 3.0, at least about 3.25, at least about 3.5, at least about 3.75, at least about 4.0, at least about 4.25, at least about 4.5, at least about 4.75, at least about 5.0, at least about 5.25, at least about 5.5, at least about 5.75, at least about 6.0, at least about 6.25, at least about 6.5, at least about 6.75, at least about 7.0, at least about 7.25, at least about 7.5, at least about 7.75, at least about 8.0, at least about 8.25, at least about 8.5, at least about 8.75, at least about 9.0, at least about 9.25, at least about 9.5, or at least about 9.75). In some embodiments, the nanobars have an aspect ratio that is about 10.0 or less (e.g., about 9.75 or less, about 9.5 or less, about 9.25 or less, about 9.0 or less, about 8.75 or less, about 8.5 or less, about 8.25 or less, about 8.0 or less, about 7.75 or less, about 7.5 or less, about 7.25 or less, about 7.0 or less, about 6.75 or less, about 6.5 or less, about 6.25 or less, about 6.0 or less, about 5.75 or less, about 5.5 or less, about 5.25 or less, about 5.0 or less, about 4.75 or less, about 4.5 or less, about 4.25 or less, about 4.0 or less, about 3.75 or less, about 3.5 or less, about 3.25 or less, about 3.0 or less, about 2.75 or less, about 2.5 or less, about 2.25 or less, about 2.0 or less, or about 1.75 or less).

Nanobars can have an aspect ratio ranging from any of the minimum values described above to any of the maximum values described above. For example, the nanobars can have an aspect ratio ranging from at least about 1.5 to about 10.0 (e.g., from at least about 1.5 to about 7.5, from at least about 1.5 to about 5.0, from at least about 1.75 to about 5.0, from at least about 2.0 to about 5.0, from at least about 2.0 to about 4.5, or from at least about 2.0 to about 4.0).

In certain embodiments, the nanobars have a length, width, and height ranging from greater than 4 nm to about 50 nm (e.g., from greater than 5 nm to about 50 nm, from greater than 4 nm to about 30 nm, from greater than 5 nm to about 30 nm, from greater than 10 nm to about 50 nm, or from greater than 10 nm to about 30 nm).

The precursor complex can comprise a metallic moiety and one or more ligands coordinated to the metallic moiety. The metallic moiety can comprise, for example, Fe²⁺, Fe³⁺, a ferric oxide, ferrous oxide, a non-ferrous metal ion, a non-ferrous metal ferrite, or combinations thereof. The non-ferrous metal ion can comprise, by way of example, Zn²⁺, Ca²⁺, Mg²⁺, Mn²⁺, Cu²⁺, Co²⁺, Cr²⁺, Ni²⁺, Na⁺, K⁺, Ba²⁺, or combinations thereof. The non-ferrous metal ferrite can comprise, by way of example, a zinc ferrite, a calcium ferrite, a magnesium ferrite, a manganese ferrite, a copper ferrite, a chromium ferrite, a cobalt ferrite, a nickel ferrite, a sodium ferrite, a potassium ferrite, a barium ferrite, or combinations thereof.

The precursor complex further comprises one or more ligands coordinated to the metallic moiety. One or more ligands can be attached to the metallic moiety, for example, by coordination bonds. Ligands can also be associated with the metallic moiety via non-covalent interactions. In some cases, the precursor complex comprises a plurality of ligands. The one or more ligands can comprise a fatty acid, a capping ligand, or a combination thereof.

In some cases, the one or more ligands comprise a fatty acid. Fatty acids are aliphatic monocarboxylic acids which comprise a carboxyl group (—COOH) at one end of a hydrocarbon chain. Fatty acids can comprise a hydrocarbon chain with less than 7 carbon atoms (i.e., a short-chain fatty acid), a hydrocarbon chain with 8 to 12 carbon atoms (i.e., a middle-chain fatty acid), or a hydrocarbon chain with more than 12 carbon atoms (i.e., a long-chain fatty acid). In some cases, the hydrocarbon chain comprises from about 4 to about 24 carbon atoms. The hydrocarbon chain can optionally include one or more branch points.

The hydrocarbon chain may be saturated or unsaturated. Saturated fatty acids are fatty acids which comprise a hydrocarbon chain which contains no carbon-carbon double bonds. Unsaturated fatty acids are fatty acids which comprise a hydrocarbon chain which contains one or more double bonds between carbon atoms. Unsaturated fatty acids can be mono- or poly-unsaturated.

In some embodiments, the fatty acid comprises a long-chain saturated fatty acid, a long-chain monounsaturated fatty acid, a long-chain polyunsaturated fatty acid, or a combination thereof. Examples of suitable saturated fatty acids include caprylic acid, capric acid, lauric acid, myristic acid, palmitic acid, stearic acid, arachidic acid, behenic acid, lignoceric acid, cerotic acid, and combinations thereof. Examples of suitable monounsaturated fatty acids include myristoleic acid, palmitoleic acid, sapienic acid, oleic acid, elaidic acid, vaccenic acid, erucic acid, eicosenoic acid, nervonic acid, and combinations thereof. Examples of suitable polyunsaturated fatty acids include linoleic acid, linoelaidic acid, α-linolenic acid, arachidonic acid, eicosapentaenoic acid, docosahexaenoic acid, mead acid, and combinations thereof.

In certain embodiments, the fatty acid comprises myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, caprylic acid, capric acid, lauric acid, myristic acid, palmitic acid, stearic acid, arachidic acid, behenic acid, lignoceric acid, cerotic acid, eicosenoic acid, mead acid, nervonic acid, or a combinations thereof. In certain embodiments, the fatty acid comprises oleic acid, and the non-spherical particle formed by the method is a nanocube. In certain embodiments, the fatty acid comprises stearic acid, and the non-spherical particle formed by the method is a nanobar.

In some cases, the one or more ligands comprise a capping ligand. Capping ligands are non-fatty acid species that can form a precursor complex via coordination to a metallic moiety. Capping ligands can comprise, for example, a phosphine moiety, an amine moiety, a thiol moiety, a siloxane moiety, or combinations thereof capable of coordination to the metallic moiety. Examples of capping ligands include, by way of example, phosphines, such as trioctylphosphine (TOP), triphenylphosphine (TPP), and 1,2-Bis(diphenylphosphino)ethane (DPPE); phosphine oxides, such as trioctylphosphine oxide (TOPO) and triphenylphosphine oxide (TPPO); amines, including alkylamines such as trioctylamine (TOA) and oleylamine, and alkylamine oxides such as lauryldimethylamine oxide; thiols, such as dodecane thiol and hexadecane thiol; siloxanes, including alkylsiloxanes; silanes, including alkylsilanes; sugars (e.g., monosaccharides, disaccharides, and/or polysaccharides) and modified sugars, including gluconic acid, lactobionic acid, and pectin; and combinations thereof. Other suitable capping ligands include Good's buffers (MES, ADA, PIPES, ACES, cholamine chloride, BES, TES, HEPES, acetamidoglycine, tricine, glycinamide, and bicine), biotin, catecholamines such as dopamine, and histamine.

Suitable precursor complexes, as well as methods of making suitable precursor complexes, are known in the art. For example, precursor complexes can be prepared by reacting a suitable metallic moiety with one or more ligands under suitable conditions. For example, mixed metal oleate complexes (e.g., Fe(III)/M(II) oleate complexes where M is, for example, Zn²⁺, Ca²⁺, Mg²⁺, Mn²⁺, Cu²⁺, Co²⁺, Cr²⁺, Ni²⁺, Na⁺, K⁺or Ba²⁺) can be prepared by reacting M-chloride and ferric chloride with sodium oleate.

The precursor complex is incubated at a temperature effective to form a population of nuclei by thermal displacement of one or more of the ligands from the metallic moiety. In some embodiments, the precursor complex is incubated at a temperature of about 100° C. or greater (e.g., about 110° C. or greater, about 120° C. or greater, about 125° C. or greater, about 130° C. or greater, about 140° C. or greater, about 150° C. or greater, about 160° C. or greater, about 170° C. or greater, about 175° C. or greater, about 180° C. or greater, about 190° C. or greater, about 200° C. or greater, about 210° C. or greater, about 220° C. or greater, about 225° C. or greater, about 230° C. or greater, about 240° C. or greater, about 250° C. or greater, about 260° C. or greater, about 270° C. or greater, about 275° C. or greater, about 280° C. or greater, or about 290° C. or greater). In some embodiments, the precursor complex is incubated at a temperature of about 300° C. or less (e.g., about 290° C. or less, about 280° C. or less, about 275° C. or less, about 270° C. or less, about 260° C. or less, about 250° C. or less, about 240° C. or less, about 230° C. or less, about 225° C. or less, about 220° C. or less, about 210° C. or less, about 200° C. or less, about 190° C. or less, about 180° C. or less, about 175° C. or less, about 170° C. or less, about 160° C. or less, about 150° C. or less, about 140° C. or less, about 130° C. or less, about 125° C. or less, about 120° C. or less, or about 110° C. or less).

The precursor complex can incubated at a temperature ranging from any of the minimum temperatures described above to any of the maximum temperatures described above. For example, the precursor complex is incubated at a temperature of from about 100° C. to about 300° C. (e.g., from about 150° C. to about 300° C., from about 200° C. to about 300 ° C., or from about 225° C. to about 275 ° C.). The precursor complex can be incubated at a single temperature within this range, or one or more temperatures within this range (e.g., via progressive elevation of the incubation temperature during the course of incubation).

The precursor complex is incubated for a period of time effective to form a population of nuclei by thermal displacement of one or more of the ligands from the metallic moiety. An appropriate period of time can be selected in view of a number of factors, including the identity of the precursor complex and the incubation temperature. In some cases, the precursor complex is incubated for about 5 minutes or longer (e.g., for about 10 minutes or longer, for about 15 minutes or longer, for about 20 minutes or longer, for about 25 minutes or longer, for about 30 minutes or longer, for about 35 minutes or longer, for about 40 minutes or longer, for about 45 minutes or longer, for about 50 minutes or longer, or for about 55 minutes or longer). In some cases, the precursor complex is incubated for about 1 hour or less (e.g., for about 55 minutes or less, for about 50 minutes or less, for about 45 minutes or less, for about 40 minutes or less, for about 35 minutes or less, for about 30 minutes or less, for about 25 minutes or less, for about 20 minutes or less, for about 15 minutes or less, or for about 10 minutes or less).

The precursor complex can be incubated for a period of time ranging from any of the minimum values described above to any of the maximum values described above. For example, the precursor complex can be incubated for a period of time ranging from about 5 minutes to about 1 hour (e.g., from about 5 minutes to about 45 minutes, from about 10 minutes to about 45 minutes, or from about 10 minutes to about 30 minutes).

Following incubation to form a population of nuclei, the nuclei can be heated to form a population of non-spherical nanoparticles. In some embodiments, the nuclei are heated at a temperature of greater than 300° C. (e.g., greater than 305° C., greater than 310° C., greater than 315° C., greater than 320° C., greater than 325° C., greater than 330° C., greater than 335° C., greater than 340° C., greater than 345° C., greater than 350° C., greater than 355° C., greater than 360° C., greater than 365° C., greater than 370° C., greater than 375° C., greater than 380° C., greater than 385° C., greater than 390° C., or greater than 395° C.). In some embodiments, the nuclei are heated at a temperature of about 400° C. or less (e.g., about 395° C. or less, about 390° C. or less, about 385° C. or less, about 380° C. or less, about 375° C. or less, about 370° C. or less, about 365° C. or less, about 360° C. or less, about 355° C. or less, about 350° C. or less, about 345° C. or less, about 340° C. or less, about 335° C. or less, about 330° C. or less, about 325° C. or less, about 320° C. or less, about 315° C. or less, about 310° C. or less, or about 305° C. or less).

The nuclei can be heated at a temperature ranging from any of the minimum temperatures described above to any of the maximum temperatures described above. For example, the nuclei can be heated at a temperature ranging from greater than 300° C. to about 400° C. (e.g., from greater than 300° C. to about 380° C., from greater than 300° C. to about 360° C., or from greater than 300° C. to about 350° C.). The nuclei can be heated at a single temperature within this range, or one or more temperatures within this range (e.g., via progressive elevation of the heating temperature during the course of heating).

The nuclei can be heated for a period of time effective to form a population of non-spherical ferrite nanoparticles having the desired size and shape. In some cases, the nuclei are heated for about 5 minutes or longer (e.g., for about 10 minutes or longer, for about 15 minutes or longer, for about 20 minutes or longer, for about 25 minutes or longer, for about 30 minutes or longer, for about 35 minutes or longer, for about 40 minutes or longer, for about 45 minutes or longer, for about 50 minutes or longer, for about 55 minutes, for about 1 hour, for about 1 hour and 5 minutes, for about 1 hour and 10 minutes, for about 1 hour and 15 minutes, for about 1 hour and 20 minutes, for about 1 hour and 25 minutes, for about 1 hour and 30 minutes, for about 1 hour and 35 minutes, for about 1 hour and 40 minutes, for about 1 hour and 45 minutes, for about 1 hour and 50 minutes, or for about 1 hour and 55 minutes). In some cases, the nuclei are heated for about 2 hours or less (e.g., for about 1 hour and 55 minutes or less, for about 1 hour and 50 minutes or less, for about 1 hour and 45 minutes or less, for about 1 hour and 40 minutes or less, for about 1 hour and 35 minutes or less, for about 1 hour and 30 minutes or less, for about 1 hour and 25 minutes or less, for about 1 hour and 20 minutes or less, for about 1 hour and 15 minutes or less, for about 1 hour and 10 minutes or less, for about 1 hour and 5 minutes or less, for about 1 hour or less, for about 55 minutes or less, for about 50 minutes or less, for about 45 minutes or less, for about 40 minutes or less, for about 35 minutes or less, for about 30 minutes or less, for about 25 minutes or less, for about 20 minutes or less, for about 15 minutes or less, or for about 10 minutes or less).

The nuclei can be heated for a period of time ranging from any of the minimum values described above to any of the maximum values described above. For example, the nuclei can be heated for a period of time ranging from about 5 minutes to about 2 hours (e.g., from about 5 minutes to about 1 hour 45 minutes, from about 5 minutes to about 1 hour 30 minutes, or from about 5 minutes to about 1 hour).

In some embodiments, the method further involves removing residual solvent from the precursor complex prior to incubation. Residual solvent can be removed using, for example, heating, reduced pressure, or combinations thereof In some embodiments, the precursor complex is heated at a temperature of from about 60° C. to about 100° C. for a period of time effective to remove residual solvent from the precursor complex prior to incubation.

Also provided are a methods of preparing non-spherical nanoparticles that comprise incubating a precursor complex comprising a metallic moiety and one or more ligands coordinated to the metallic moiety at a temperature of from about 100° C. to about 300° C. for a period of time effective to form a population of non-spherical nanoparticles by thermal displacement of one or more of the ligands from the metallic moiety, and adding a ligand mixture comprising one or more fatty acids and one or more capping ligands, wherein the molar ratio of the fatty acids to the capping ligands ranges from 2:1 to 1:10.

The shape and size of the non-spherical nanoparticles formed by this method can be selected based on a number of factors, including the composition of the precursor complex (e.g., the identity and/or quantity of the ligands coordinated to the metallic moiety), the incubation conditions (e.g., incubation temperature, duration, or combinations thereof), and the composition of the ligand mixture (e.g., the identity of the ligands in the mixture and the ratio of ligands in the ligand mixture). In some embodiments, the population of non-spherical particles formed by this method is monodisperse.

In some embodiments, the smallest dimension of the non-spherical nanoparticles prepared by this method is greater than 3 nm (e.g., greater than 4 nm, greater than 5 nm, greater than 6 nm, greater than 7 nm, greater than 8 nm, greater than 9 nm, greater than 10 nm, greater than 11 nm, greater than 12 nm, greater than 13 nm, greater than 14 nm, greater than 15 nm, greater than 20 nm, greater than 25 nm, greater than 30 nm, greater than 35 nm, greater than 40 nm, or greater than 45 nm). In some cases, the smallest dimension of the non-spherical nanoparticles is about 50 nm or less (e.g., about 45 nm or less, about 40 nm or less, about 35 nm or less, about 30 nm or less, about 25 nm or less, about 20 nm or less, about 15 nm or less, about 10 nm or less, about 9 nm or less, about 8 nm or less, about 7 nm or less, about 6 nm or less, about 5 nm or less, or about 4 nm or less).

The smallest dimension of the non-spherical nanoparticles prepared by this method can range from any of the minimum values described above to any of the maximum values described above. For example, the smallest dimension of the non-spherical nanoparticles can range from greater than 3 nm to about 50 nm (e.g., from greater than 4 nm to about 50 nm, from greater than 5 nm to about 50 nm, from greater than 3 nm to about 30 nm, from greater than 4 nm to about 30 nm, from greater than 5 nm to about 30 nm, from greater than 10 nm to about 50 nm, or from greater than 10 nm to about 30 nm).

In some embodiments, the non-spherical nanoparticles formed by this method comprise nanoplates. Nanoplates are nanostructures which possess lateral dimensions (i.e., a height and width defined by edge lengths) that are substantially larger than the nanoplate's thickness. The height and width of the nanoplates can be approximately the same, or different.

Nanoplates can be defined by their aspect ratio, defined as the shortest lateral dimension of the nanoplate divided by the thickness of the nanoplate. Nanoplates can have an aspect ratio of at least about 5.0 (e.g., at least about 5.5, at least about 6.0, at least about 6.5, at least about 7.0, at least about 7.5, at least about 8.0, at least about 8.5, at least about 9.0, at least about 10.0, at least about 11.0, at least about 12.0, at least about 13.0, or at least about 14.0). In some embodiments, the nanoplates have an aspect ratio that is about 15.0 or less (e.g., about 14.0 or less, about 13.0 or less, about 12.0 or less, about 11.0 or less, about 10.0 or less, about 9.0 or less, about 8.5 or less, about 8.0 or less, about 7.5 or less, about 7.0 or less, about 6.5 or less, about 6.0 or less, or about 5.5 or less).

Nanoplates can have an aspect ratio ranging from any of the minimum values described above to any of the maximum values described above. For example, the nanoplates can have an aspect ratio ranging from at least about 5.0 to about 15.0 (e.g., from at least about 5.0 to about 12.0, from at least about 5.0 to about 10.0, or from at least about 6.0 to about 10.0).

In certain embodiments, the non-spherical nanoparticles comprise nanoplates having a thickness ranging from greater than 3 nm to about 10 nm (e.g., from greater than 4 nm to about 10 nm, from greater than 3 nm to about 8 nm, or from greater than 4 nm to about 8 nm). In certain embodiments, the non-spherical nanoparticles comprise nanoplates having lateral dimensions and a thickness ranging from greater than 3 nm to about 50 nm (e.g., from greater than 4 nm to about 50 nm, from greater than 5 nm to about 50 nm, from greater than 3 nm to about 30 nm, from greater than 4 nm to about 30 nm, from greater than 5 nm to about 30 nm, from greater than 10 nm to about 50 nm, or from greater than 10 nm to about 30 nm).

In some embodiments, the non-spherical nanoparticles formed by this method comprise nanoflowers. Nanoflowers, so-named because their morphology often resembles a flower, are 3-dimensional nanostructures formed from the assembly of a plurality smaller crystal grains. The crystal grains can individually range in size from about 2 nm to about 10. The resulting nanoflowers can have one or more dimensions ranging from greater 4 nm to about 50 nm.

In certain embodiments, the nanoflowers have a length, width, and height ranging from greater than 3 nm to about 50 nm (e.g., from greater than 4 nm to about 50 nm, from greater than 5 nm to about 50 nm, from greater than 3 nm to about 30 nm, from greater than 4 nm to about 30 nm, from greater than 5 nm to about 30 nm, from greater than 10 nm to about 50 nm, or from greater than 10 nm to about 30 nm).

The precursor complex can comprise a metallic moiety and one or more ligands coordinated to the metallic moiety, as described above. In certain cases, the precursor complex comprises an iron oleate complex.

The precursor complex is incubated at a temperature effective to form a population of non-spherical particles by thermal displacement of one or more of the ligands from the metallic moiety. In some embodiments, the precursor complex is incubated at a temperature of about 100° C. or greater (e.g., about 110° C. or greater, about 120° C. or greater, about 125° C. or greater, about 130° C. or greater, about 140° C. or greater, about 150° C. or greater, about 160° C. or greater, about 170° C. or greater, about 175° C. or greater, about 180° C. or greater, about 190° C. or greater, about 200° C. or greater, about 210° C. or greater, about 220° C. or greater, about 225° C. or greater, about 230° C. or greater, about 240° C. or greater, about 250° C. or greater, about 260° C. or greater, about 270° C. or greater, about 275° C. or greater, about 280° C. or greater, or about 290° C. or greater). In some embodiments, the precursor complex is incubated at a temperature of about 300° C. or less (e.g., about 290° C. or less, about 280° C. or less, about 275° C. or less, about 270° C. or less, about 260° C. or less, about 250° C. or less, about 240° C. or less, about 230° C. or less, about 225° C. or less, about 220° C. or less, about 210° C. or less, about 200° C. or less, about 190° C. or less, about 180° C. or less, about 175° C. or less, about 170° C. or less, about 160° C. or less, about 150° C. or less, about 140° C. or less, about 130° C. or less, about 125° C. or less, about 120° C. or less, or about 110° C. or less).

The precursor complex can incubated at a temperature ranging from any of the minimum temperatures described above to any of the maximum temperatures described above. For example, the precursor complex is incubated at a temperature of from about 100° C. to about 300° C. (e.g., from about 150° C. to about 300° C., from about 200° C. to about 300 ° C., or from about 225° C. to about 275 ° C.). The precursor complex can be incubated at a single temperature within this range, or one or more temperatures within this range (e.g., via progressive elevation of the incubation temperature during the course of incubation).

The precursor complex is incubated for a period of time effective to form a population of non-spherical particles by thermal displacement of one or more of the ligands from the metallic moiety. An appropriate period of time can be selected in view of a number of factors, including the identity of the precursor complex and the incubation temperature. In some cases, the precursor complex is heated for about 5 minutes or longer (e.g., for about 10 minutes or longer, for about 15 minutes or longer, for about 20 minutes or longer, for about 25 minutes or longer, for about 30 minutes or longer, for about 35 minutes or longer, for about 40 minutes or longer, for about 45 minutes or longer, for about 50 minutes or longer, for about 55 minutes, for about 1 hour, for about 1 hour and 5 minutes, for about 1 hour and 10 minutes, for about 1 hour and 15 minutes, for about 1 hour and 20 minutes, for about 1 hour and 25 minutes, for about 1 hour and 30 minutes, for about 1 hour and 35 minutes, for about 1 hour and 40 minutes, for about 1 hour and 45 minutes, for about 1 hour and 50 minutes, or for about 1 hour and 55 minutes). In some cases, the precursor complex is heated for about 2 hours or less (e.g., for about 1 hour and 55 minutes or less, for about 1 hour and 50 minutes or less, for about 1 hour and 45 minutes or less, for about 1 hour and 40 minutes or less, for about 1 hour and 35 minutes or less, for about 1 hour and 30 minutes or less, for about 1 hour and 25 minutes or less, for about 1 hour and 20 minutes or less, for about 1 hour and 15 minutes or less, for about 1 hour and 10 minutes or less, for about 1 hour and 5 minutes or less, for about 1 hour or less, for about 55 minutes or less, for about 50 minutes or less, for about 45 minutes or less, for about 40 minutes or less, for about 35 minutes or less, for about 30 minutes or less, for about 25 minutes or less, for about 20 minutes or less, for about 15 minutes or less, or for about 10 minutes or less).

The precursor can be heated for a period of time ranging from any of the minimum values described above to any of the maximum values described above. For example, the precursor can be heated for a period of time ranging from about 5 minutes to about 2 hours (e.g., from about 5 minutes to about 1 hour 45 minutes, from about 15 minutes to about 1 hour 45 minutes, or from about 30 minutes to about 1 hour 30 minutes).

A ligand mixture can be added to the precursor complex to direct nanoparticles formation. The ligand mixture can be added to the precursor complex at any point before or during incubation. In some cases, the ligand mixture is added to the precursor complex prior to incubation. In some embodiments, the ligand mixture is added to the precursor complex during incubation. For example the ligand mixture can be added to the precursor complex at a point in time after at least about 5% of the incubation period had elapsed (e.g., at a point in time after at least about 10% of the incubation period had elapsed, at a point in time after at least about 20% of the incubation period had elapsed, at a point in time after at least about 25% of the incubation period had elapsed, at a point in time after at least about 30% of the incubation period had elapsed, at a point in time after at least about 40% of the incubation period had elapsed, at a point in time after at least about 50% of the incubation period had elapsed, at a point in time after at least about 60% of the incubation period had elapsed, at a point in time after at least about 70% of the incubation period had elapsed, at a point in time after at least about 75% of the incubation period had elapsed, or at a point in time after at least about 80% of the incubation period had elapsed). The ligand mixture can be added at one time, or as a series of aliquots throughout the course of nanoparticles synthesis. When added as aliquots, each aliquot can have the same or different chemical composition.

The ligand mixture comprises one or more fatty acids and one or more capping ligands. The fatty acids present in the ligand mixture can be any of the fatty acids described above. In some embodiments, the fatty acids in the ligand mixture comprise a long-chain saturated fatty acid, a long-chain monounsaturated fatty acid, a long-chain polyunsaturated fatty acid, or a combination thereof. Examples of suitable saturated fatty acids include caprylic acid, capric acid, lauric acid, myristic acid, palmitic acid, stearic acid, arachidic acid, behenic acid, lignoceric acid, cerotic acid, and combinations thereof. Examples of suitable monounsaturated fatty acids include myristoleic acid, palmitoleic acid, sapienic acid, oleic acid, elaidic acid, vaccenic acid, erucic acid, eicosenoic acid, nervonic acid, and combinations thereof. Examples of suitable polyunsaturated fatty acids include linoleic acid, linoelaidic acid, α-linolenic acid, arachidonic acid, eicosapentaenoic acid, docosahexaenoic acid, mead acid, and combinations thereof.

In certain embodiments, the fatty acids in the ligand mixture comprise myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, caprylic acid, capric acid, lauric acid, myristic acid, palmitic acid, stearic acid, arachidic acid, behenic acid, lignoceric acid, cerotic acid, eicosenoic acid, mead acid, nervonic acid, or a combinations thereof In certain embodiments, the fatty acids in the ligand mixture comprise oleic acid.

The capping ligands present in the ligand mixture can be non-fatty acid species that coordinate to the metallic moiety of the precursor complex. Capping ligands can comprise, for example, a phosphine moiety, an amine moiety, a thiol moiety, a siloxane moiety, or combinations thereof capable of coordination to the metallic moiety. Examples of capping ligands include, by way of example, phosphines, such as trioctylphosphine (TOP), triphenylphosphine (TPP), and 1,2-Bis(diphenylphosphino)ethane (DPPE); phosphine oxides, such as trioctylphosphine oxide (TOPO) and triphenylphosphine oxide (TPPO); amines, including alkylamines such as trioctylamine (TOA) and oleylamine, and alkylamine oxides such as lauryldimethylamine oxide; thiols, such as dodecane thiol and hexadecane thiol; siloxanes, including alkylsiloxanes; silanes, including alkylsilanes; sugars (e.g., monosaccharides, disaccharides, and/or polysaccharides) and modified sugars, including gluconic acid, lactobionic acid, and pectin; and combinations thereof Other suitable capping ligands include Good's buffers (MES, ADA, PIPES, ACES, cholamine chloride, BES, TES, HEPES, acetamidoglycine, tricine, glycinamide, and bicine), biotin, catecholamines such as dopamine, and histamine.

The molar ratio of fatty acids to capping ligands in the ligand mixture can be selected to induce formation of nanoparticles having the desired morphology. In some embodiments, the molar ratio of fatty acids to capping ligands in the ligand mixture is about 2:1 or less (e.g., 1.5:1 or less, 1:1 or less, 1:1.5 or less, 1:2 or less, 1:3 or less, 1:4 or less, 1:5 or less, 1:6 or less, 1:7 or less, 1:8 or less, or 1:9 or less). In some embodiments, the molar ratio of fatty acids to capping ligands in the ligand mixture is at least 1:10 (e.g., at least 1:9, at least 1:8, at least 1:7.5, at least 1:7, at least 1:6, at least 1:5, at least 1:4, at least 1:3, at least 1:2, at least 1:1.5, at least 1:1, at least 1.5:1).

The ligand mixture can comprise a molar ratio of fatty acids to capping ligands ranging from any of the minimum ratios described above to any of the maximum ratios described above. For example, the molar ratio of fatty acids to capping ligands can range from 2:1 to 1:10 (e.g., from about 1.5:1 to about 1:8, or from 1:1 to 1:5).

Also provided are methods of functionalizing the surface of a metal or metal oxide particle. Methods of functionalizing the surface of a metal or metal oxide particles can involve coordinating a catecholamine to the metal or metal oxide particle surface via the amine moiety of the catecholamine, oxidizing the catechol moiety of the catecholamine to form a benzoquinone moiety, and conjugating a functional agent comprising a nucleophilic moiety to the catecholamine by reacting the benzoquinone moiety of the catecholamine with the nucleophilic moiety of the functional agent.

The particles can be microparticles or nanoparticles. The microparticles can be particles of any shape (e.g., microspheres, microrods, microcubes, etc.) whose dimensions range, for example, from about 1 micron to about 10 microns. The nanoparticles can be particles of any shape (e.g., nanospheres, nanorods, nanocubes, nanobars, nanoplates, nanoflowers, etc.) whose dimensions range, for example, from about 1 nm up to, but not including, about 1 micron. The particles can be, for example, noble metal particles comprising, for example, Au, Ag, Pt, Pd, and combinations thereof The particles can also be metal oxide particles, such as ferrite particles. In some cases, the particles are ferrite nanoparticles (e.g., magnetite (Fe₃O₄) nanoparticles, maghemite (Fe₂O₃) nanoparticles, zinc ferrite nanoparticles, calcium ferrite nanoparticles, magnesium ferrite nanoparticles, manganese ferrite nanoparticles, copper ferrite nanoparticles, chromium ferrite nanoparticles, cobalt ferrite nanoparticles, nickel ferrite nanoparticles, sodium ferrite nanoparticles, potassium ferrite nanoparticles, barium ferrite nanoparticles, or nanoparticles comprising a combination of these ferrites.

A catecholamine can be coordinated to the metal or metal oxide particle surface. Catecholamines are organic compounds comprising a catechol moiety and a side-chain comprising an amine group (e.g., a primary amine group). Other ligands may optionally be present on the particle surface.

The side chain of the catecholamine can comprise, for example, an alkyl or alkylaryl group. Alkyl, as used herein, refers to the radical of saturated or unsaturated aliphatic groups, including straight-chain alkyl, alkenyl, or alkynyl groups, branched-chain alkyl, alkenyl, or alkynyl groups, cycloalkyl, cycloalkenyl, or cycloalkynyl (alicyclic) groups, alkyl substituted cycloalkyl, cycloalkenyl, or cycloalkynyl groups, and cycloalkyl substituted alkyl, alkenyl, or alkynyl groups. In some embodiments, the alkyl group comprises 30 or fewer carbon atoms in its backbone (e.g., C₁-C₃₀ for straight chain, C₃-C₃₀ for branched chain). For example, the alkyl group can comprise 20 or fewer carbon atoms, 12 or fewer carbon atoms, 8 or fewer carbon atoms, or 6 or fewer carbon atoms in its backbone. The term alkyl includes both unsubstituted alkyls and substituted alkyls, the latter of which refers to alkyl groups having one or more substituents, such as a halogen or a hydroxy group, replacing a hydrogen on one or more carbons of the hydrocarbon backbone. The alkyl groups can also comprise between one and four heteroatoms (e.g., oxygen, nitrogen, sulfur, and combinations thereof) within the carbon backbone of the alkyl group. Alkylaryl, as used herein, refers to an alkyl group substituted with an aryl group (e.g., an aromatic or heteroaromatic group, such as a phenyl group).

In some cases, the catecholamine can be a natural catecholamine, such as dopamine, L-DOPA (L-3,4-dihydroxyphenylalanine), norepinephrine, or a combinations thereof. The catecholamine can also be a synthetic derivative or analog of a natural catecholamine, such as carbidopa ((2S)-3-(3,4-dihydroxyphenyl)-2-hydrazino-2-methylpropanoic acid), benserazide ((RS)-2-amino-3-hydroxy-N′-(2,3,4-trihydroxybenzyl)propanehydrazide), 4-(2-amino-1-methylethyl)-1,2-benzenediol, 4-(1-Amino-2-propanyl)-1,2-benzenediol, 4-(2-amino-1-hydroxyethyl)-5-chloro-1,2-benzenediol, levonordefrin (4-[(1R,2S)-2-amino-1-hydroxypropyl]benzene-1,2-diol), or combinations thereof.

The catecholamine can be coordinated to the metal or metal oxide particle surface via the amine moiety of the catecholamine The catechol moiety of the catecholamine ligand thus remains un-coordinated, and is extended towards solution.

The catechol moiety can then be activated for conjugation by oxidizing the catechol moiety of the catecholamine to form a benzoquinone moiety. In some embodiments, the catechol moiety is activated by contacting the catechol moiety with a basic solution, such as a sodium hydroxide solution having a pH of 8.0 or greater.

A functional agent comprising a nucleophilic moiety, such as amino group, a thiol group, or combinations thereof, can then be conjugated to the particle by reacting the benzoquinone moiety of the catecholamine with the nucleophilic moiety of the functional agent.

The functional agent can comprise, for example, an organic small molecule, a synthetic polymer, a synthetic oligomer, a peptide, a protein, a polysaccharide, an organometallic compound, a nucleic acid, an inorganic nanostructure, or combinations thereof.

In some cases, the functional agent comprises a bioactive agent. Bioactive agents are physiologically or pharmacologically active substance that act locally and/or systemically in vivo. Bioactive agents can include agents that are administered to a patient for the treatment (e.g., therapeutic agent), prevention (e.g., prophylactic agent), or diagnosis (e.g., diagnostic agent) of a disease or disorder. Bioactive agents can be small molecule active agents or biomolecules, such as enzymes, proteins, polypeptides, or nucleic acids. Suitable small molecule active agents can include organic and organometallic compounds. In some instances, the small molecule active agent has a molecular weight of less than about 2,000 g/mol (e.g., less than about 1,500 g/mol, less than about 1,200 g/mol, or less than about 800 g/mol). The small molecule active agent can be a hydrophilic, hydrophobic, or amphiphilic compound.

In some embodiments, the functional agent comprises a targeting agent. Targeting agents are chemical entities which direct the conjugated particle to a particular site or cause the conjugated particle to remain in a particular site when administered (e.g., in vivo or in vitro). The targeting agent may be a small molecule, peptide, protein, biological molecule, polynucleotide, etc. Targeting agents are known in the art, and can include antibodies, ligands of known receptors, and receptors.

In some embodiments, the functional agent comprises a molecule which modifies the solubility, surface charge, hydrophobicity/hydrophilicity, and/or bioavailability of the particles. For example, a hydrophilic polymer or oligomer, such as a polyalkylene oxide (e.g., polyethylene oxide), can be conjugated to the surface of particles to improve aqueous solubility, increase blood circulation time, and/or minimize immune clearance.

Surface functionalization can be accomplished without the use of a chemical linker and/or additional reagents to promote the formation of covalent bonds (e.g., catalysts such as carbodiimides). The methods can provide a convenient route for the conjugation of a range of molecules, including bioactive agents, to the surface of metal and metal oxide particles.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

### Synthesis of Iron Oxide and Doped Iron Oxide Nanocubes and Nanobars

The preparation of iron oxide and doped iron oxide nanocubes includes two major steps: precursor preparation and nanocube formation.

In the first step, Fe(III)/M(II) (M=Fe, Ca, Mg, Zn, Mn, Cu, or Mg) mixed oleate precursor complex was prepared by reacting the desired M²⁺ chloride and ferric chloride (FeCl₃) with sodium oleate in a solvent mixture (hexane/ethanol/de-ionized water) at 65° C. for four hours. After phase separation, the M(II)/Fe(III)-oleate complex was isolated and used as precursor for the synthesis of magnetic ferrite nanocubes. The entire process was performed under inert gas protection to prevent the oxidation of air sensitive ions, such as Fe(II).

Ferrite nanocubes were subsequently prepared from the precursor M(II)/Fe(III) oleate complexes. The M(II)/Fe(III)oleate complexes were heated in 1-octadecene in the presence of capping molecules (oleic acid-OA and trioctyl phosphine oxide-TOPO). Temperature gradient control was then used to elicit nanocube formation. First, the reactants were held at 100° C. for 1 hour to remove the residual solvents from the precursor complex. The mixture was then heated to 250° C.-290° C., and held at this temperature for 20 minutes to 1 hour. This step is important for the cubic shape formation because of slow formation of cubic nuclei at this temperature. Finally, the reaction mixture was heated to 320° C. for 30 minutes, allowing for NP growth and nanocube formation.

Transmission electron microcopy (TEM) images of ferrite nanocubes doped with a variety of metals (Mg, FIG. 1A; Cu, FIG. 1B; Ca, FIG. 1C; Zn, FIG. 1D; Fe, FIG. 1E; Mn, FIG. 1F) are shown in FIG. 1. TEM images revealed that monodisperse3 populations of ferrite nanoparticles doped with a variety of metals could be prepared using this temperature gradient control method. As indicated by the high resolution TEM images, the resulting nanocubes were highly crystalline in nature.

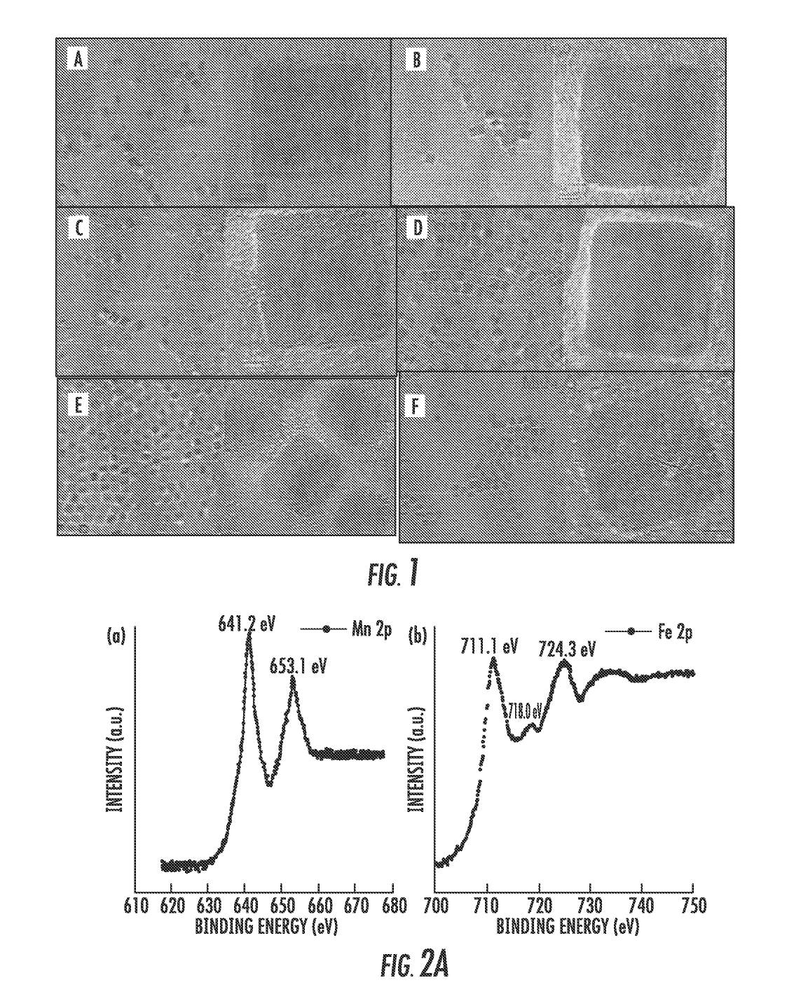

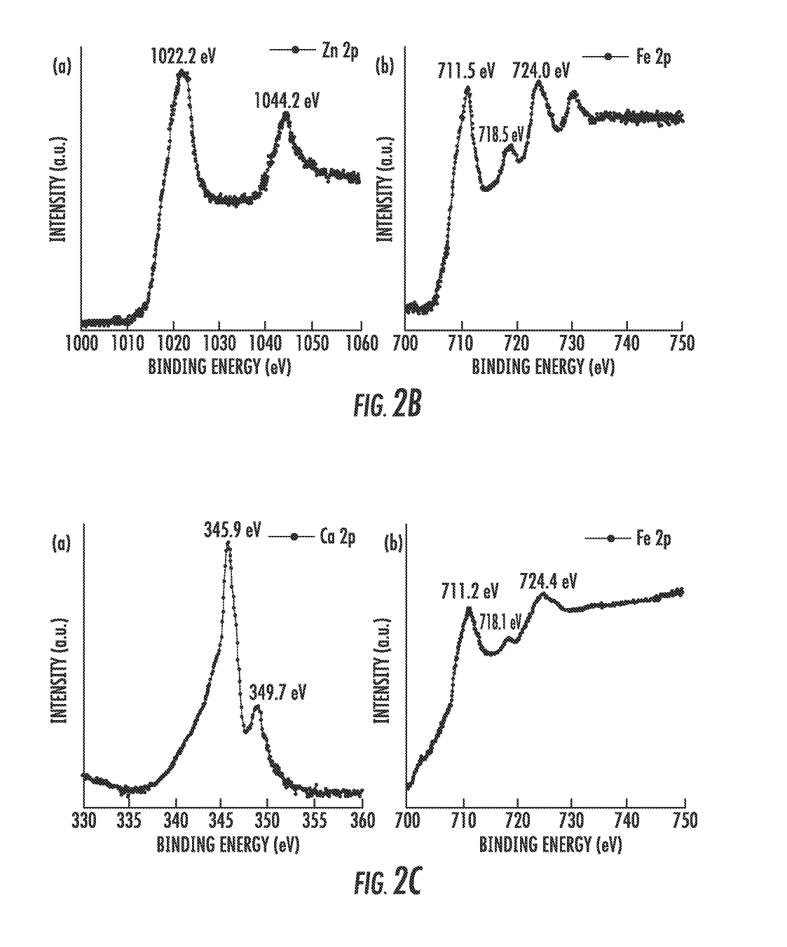

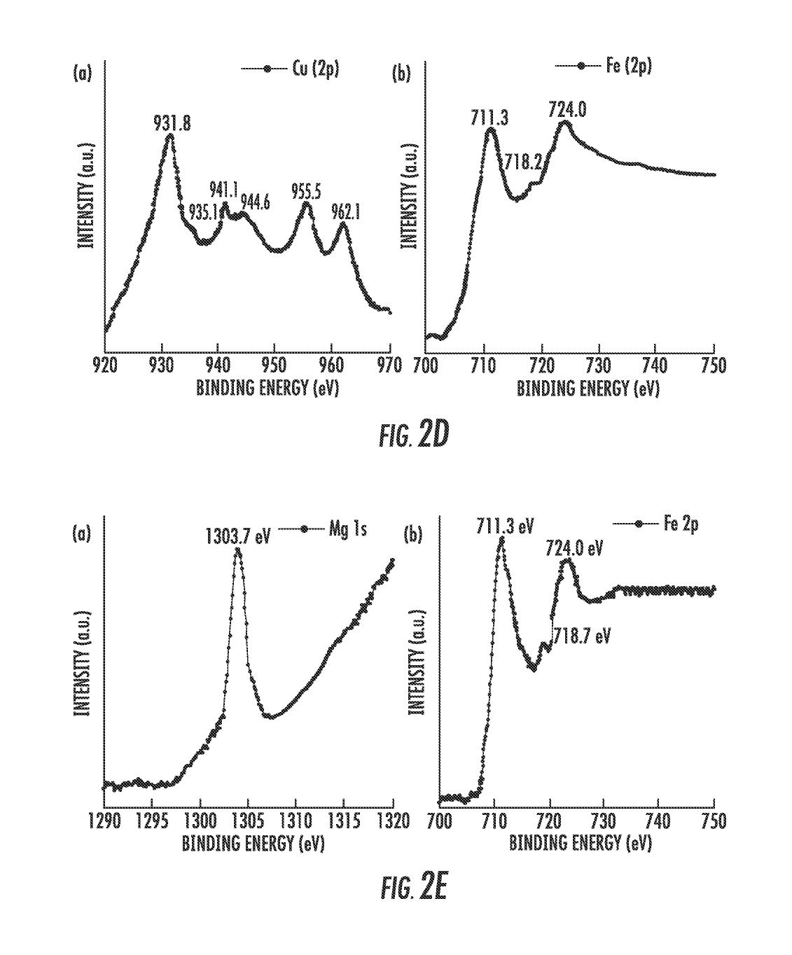

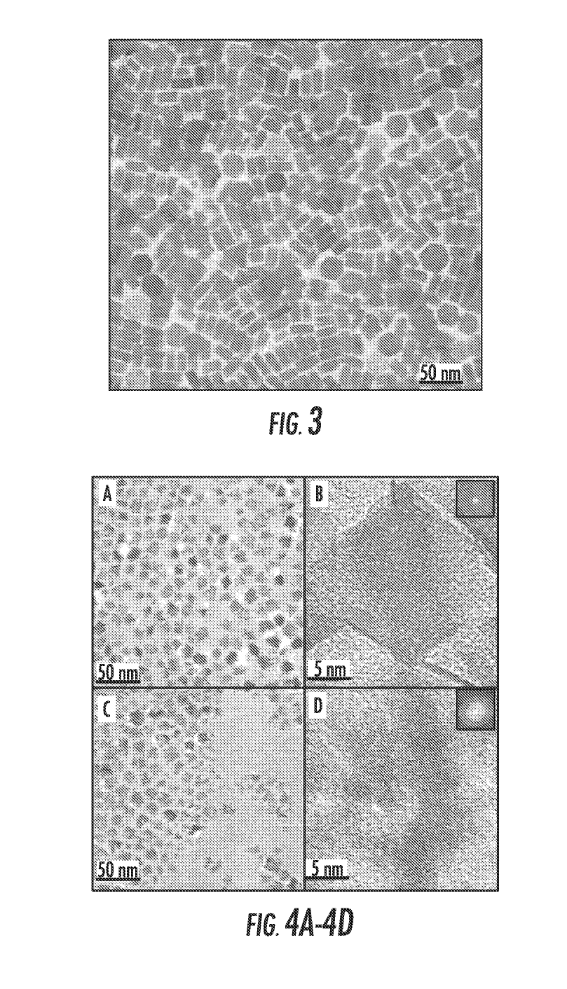

The crystal structure and relative ion ratios of the nanocubes were studied with x-ray photoelectron spectroscopy (XPS). XPS provides detailed information regarding the valence states of the inorganic ions in the nanocubes, as well as the relative ratios of different ions in the nanocubes. The XPS results obtained for ferrite nanocubes doped with a variety of metals are included in FIGS. 2A-2E, and summarized in Table 1. The particle sizes reported in Table 1 were measured using TEM.

TABLE 1
Summary of size and atomic dimensions for ferrite nanocubes

| Materials | Size (TEM) | Spectra of M²⁺ | | Spectra of Fe³⁺ | | M²⁺ to Fe³⁺ ratio |
|---|---|---|---|---|---|---|
| Fe₂O₃ | 13 | No Fe²⁺ | | Fe³⁺ 2p_{3/2} | (711.1 eV) | N/A |
| | | | | Fe³⁺ 2p_{1/2} | (724.2 eV) | |
| | | | | Satellite | (718.1 eV) | |
| Fe₃O₄ | 12 | Fe²⁺ 2p_{1/2} | (709 eV) | Fe³⁺ 2p_{3/2} | (711.1 eV) | N/A |
| | | and no satellite peak | | Fe³⁺ 2p_{1/2} | (724.2 eV) | |
| | | | | Satellite | (no peak) | |
| MnFe₂O₄ | 12 | Mn²⁺ 2p_{3/2} | (641.2 eV) | Fe³⁺ 2p_{3/2} | (711.1 eV) | 1:1.90 |
| | | Mn²⁺ 2p_{1/2} | (653.1 eV) | Fe³⁺ 2p_{1/2} | (724.3 eV) | |
| | | | | Satellite | (718.0 eV) | |
| CuFe₂O₄ | 12 | Cu²⁺ 2p_{3/2} | (931.8 eV) | Fe³⁺ 2p_{3/2} | (711.3 eV) | 1:2.21 |
| | | Cu²⁺ 2p_{3/2} | (935.1 eV) | Fe³⁺ 2p_{1/2} | (724.0 eV) | |
| | | Cu²⁺ 2p_{1/2} | (955.5 eV) | Satellite | (718.2 eV) | |
| CaFe₂O₄ | 12 | Ca²⁺ 2p_{3/2} | (345.9 eV) | Fe³⁺ 2p_{3/2} | (711.2 eV) | 1:2.20 |
| | | Ca²⁺ 2p_{1/2} | (349.7 eV) | Fe³⁺ 2p_{1/2} | (724.4 eV) | |
| | | | | Satellite | (718.1 eV) | |
| ZnFe₂O₄ | 18 | Zn²⁺ 2p_{3/2} | (1022.2 eV) | Fe³⁺ 2p_{3/2} | (711.5 eV) | 1:1.83 |
| | | Zn²⁺ 2p_{1/2} | (1044.2 eV) | Fe³⁺ 2p_{1/2} | (724.0 eV) | |
| | | | | Satellite | (718.5 eV) | |
| MgFe₂O₄ | 18 | Mg²⁺ 1s | (1303.7 eV) | Fe³⁺ 2p_{3/2} | (711.3 eV) | 1:2.25 |
| | | | | Fe³⁺ 2p_{1/2} | (724.0 eV) | |
| | | | | Satellite | (718.7 eV) | |

The Fe 2p core-level XPS spectrum of MnFe₂O₄ nanocubes (FIG. 2A) revealed a satellite peak at 718.0 eV, and two major peaks localized at 711.1 (Fe 2p_{3/2}) and 724.3 eV (Fe 2p_{1/2}). This pattern is consistent with the presence of Fe³⁺ in the MnFe₂O₄ nanocubes. The Mn 2p (641.2 and 653.1 eV for Mn 2p_{3/2} and Mn 2p_{1/2}) signals in the XPS spectrum is consistent with the presence of Mn²⁺ in MnFe₂O₄.

XPS spectra of ZnFe₂O₄ nanocubes (FIG. 2B) revealed the presence of Fe³⁺. Peaks were localized at 711.5 (Fe 2p_{3/2}) and 724.0 eV (Fe 2p_{1/2}) and 718.5 eV (satellite binding energy), a pattern consistent with the presence of Fe³⁺ and the absence of Fe2+. The peaks at 1022.2 and 1044.2 eV were attributed to Zn 2p_{3/2} and Zn 2p_{1/2} respectively. This finding confirmed the oxidization state of Zn^{2+,} and also the success Zn-doping into ZnFe₂O₄ nanoparticles.

XPS spectra of CaFe₂O₄ nanocubes are shown in FIG. 2C. Similar to other ferrite nanocubes, the Fe 2p spectra included peaks at 711.2, 724.4 and 718.1 eV, representing the Fe 2p_{3/2}, Fe 2p_{1/2} and the satellite binding energy due to the existence of Fe³⁺ valence state. Ca 2p spectra presented two major characteristic peaks, 345.9 and 349.7 eV for Ca 2p_{3/2} and Ca 2p_{1/2} binding energies, confirming the presence of Ca²⁺ within CaFe₂O₄ nanoparticles.

The Cu 2p and Fe 2p core-level XPS spectra of CuFe₂O₄ nanocubes are shown FIG. 2D. The Fe 2p core-level region was similar to that observed for the other ferrite nanocubes discussed above. The Cu 2p XPS spectra showed multiple peaks with several strong satellite peaks, consistent with the presence of Cu in the +2 oxidation state. The major Cu 2p peaks (located at 931.8 and 955.5 eV) were consistent with Cu²⁺ ions present in octahedral sites of the spinel structure of CuFe₂O₄ nanocubes. The minor Cu 2p peaks (located at 941.0 and 962.1 eV) were attributed to tetrahedral-site Cu²⁺ doping. An asymmetric XPS plot shape was observed at higher binding energy position, which further confirmed the partially inverted spinel structure of the CuFe₂O₄ nanocubes.

The Fe 2p and Mg 1s core-level XPS spectra collected from MgFe₂O₄ nanocubes are shown in FIG. 2E. The Mg 1s spectra showed a peak at 1303.7, consistent the presence of Mg²⁺ ions present in the octahedral sites of the MgFe₂O₄ nanocubes

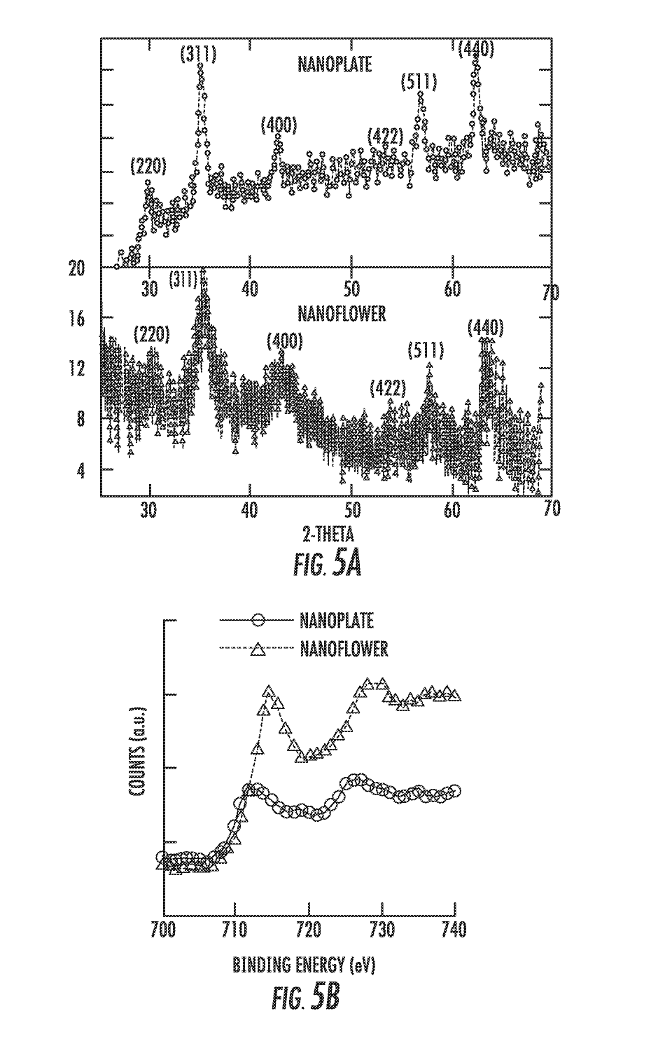

Iron oxide nanobars were also prepared using a similar synthetic methodology. An Fe(III) stearate complex was heated in 1-octadecene in the presence of capping molecules (oleic acid-OA and trioctyl phosphine oxide-TOPO). Temperature gradient control was then used to elicit nanobar formation. First, the reactants were held at 100° C. for 1 hour to remove the residual solvents from the precursor complex. The mixture was then heated to 250° C., and held at this temperature for 20 minutes. Finally, the reaction mixture was heated to 320° C. for 30 minutes, allowing for NP growth and nanobar formation. A TEM image of the ferrite nanobars is shown in FIG. 3. The nanobars possessed at least one dimension larger than 4 nm, and had aspect ratios ranging from 1:2 to 1:10.

### Example 2

### Synthesis of Iron Oxide Nanoplates and Nanoflowers

Iron oxide nanoplates and nanoflowers were synthesized.

An iron oleate complex was prepared by reacting ferric chloride (6.5 g) and potassium oleate (96.2 g) in a solvent mixture (hexane/water/ethanol). After phase separation, the hexane phase containing the iron oleate complex was washed with de-ionized water to remove by-products, and stored as the precursor. The hexane accounted for 6.5 wt %. The iron oleate hexane solution (as opposed to a well-dried iron oleate waxy paste) was used as a precursor for two reasons: it provides for easy operation and control of the reaction temperature. The presence of hexane, a low-boiling temperature solvent, facilitates maintanence of the reaction temperature at 290° C.

Iron oxide nanoplates and nanoflowers were synthesized by varying the ratio of oleic acid to TOPO present during nanoparticle synthesis (OA/TOPO=1:1 for nanoplates and OA/TOPO=1:5 for nanoflowers). Specifically, iron oleate precursor (1.82 g) in 1-octadecene (13 mL) was heated at 290° C. for an hour in the presence of oleic acid (0.1 mL) and TOPO (0.2 g for nanoplates or 1 g for nanoplowers). After synthesis, the nanoparticles were centrifuged out of solution for further characterization

By modifying the synthetic procedure, iron oxide nanoplates (˜3 nm thick) and nanoflowers of ˜20 nm were obtained through the decomposition of iron oleate by controlling the nucleation and nanoparticle growth. Specifically, the nucleation and growth processes could be significantly altered by the reaction temperature and the amount of a ligand with lower affinity to iron ions (e.g., trioctylphosphine oxide; TOPO)

Under similar reaction conditions, two distinct growth pathways of NPs were observed. Under diffusional growth condition, the presence of C₂H_{S}O⁻, a residual product from the precursor reaction, played an important role in the nanoplate formation. In contrast, the aggregation of small iron oxide nanocrystals led to the formation of iron oxide nanoflowers under a condition of high nucleus concentration.

In this case, nanomaterials synthesis was performed at a reaction temperature of 290° C. This temperature is high enough to decompose all three ligands of the iron oleate precursor, but is below the burst nucleation temperature (>300° C.). Within this temperature range, the ratio of TOPO could be used to alter the nucleation event.

Iron oxide nanoplates with a side length of ˜18 nm were produced when TOPO/OA (1.65/1) was used. As shown in FIGS. 4A and 4B, the nanoplates were highly crystalline, as suggested by the lattice fringes of the HRTEM image (FIG. 4B), and the ordered dot pattern of the fast Fourier transformation (FFT) image (FIG. 4B, Inset). The HRTEM image was obtained with a 30° α-tilt angle, and confirmed the thickness of the nanoplates was approximately 3 nm.

Iron oxide nanoflowers (˜20 nm) were produced by increasing the TOPO to OA ratio 5 times. As shown in FIGS. 4C and 4D, the nanofloweres were composed of many small (˜5 nm) iron oxide nanocrystals. This was further supported by the ring dot pattern of the FFT image (FIG. 4D, Inset).

FIG. 5A shows the x-ray diffraction (XRD) patterns of the nanoplates (top) and nanoflowers (bottom). Both XRD patterns included peaks characteristic of iron oxide. The XRD patterns could not conclusively differentiate magnetite (Fe₃O₄) or maghemite (γ-Fe₂O₃) due to the size broadening, as well as their structural similarity.

To address this issue, x-ray photoelectron spectroscopy (XPS) analysis was performed to study the Fe and O valance states of the nanoplates and nanoflowers. The XPS spectra of iron oxides exhibit satellite peaks, which are highly sensitive to the electronic structure of the compounds. Thus, XPS could be used to effectively differentiate between these two common iron oxide crystal phases.

The XPS Fe₂ₚ core-level spectra of the nanoplates and nanoflowers were shown in FIG. 5B. The two major peaks of the nanoplates (712.7 and 726.0 eV) and nanoflowers (715.0 and 728.5 eV) corresponded to the 2p3/2 and 2p1/2 core-levels of iron oxides. The satellite peak around 718.0 eV of the nanoplate spectrum suggested a γ-Fe₂O₃ phase. In contrast, the absence of this peak in the nanoflower spectrum indicated a magnetite phase. This conclusion was further supported by the O₁ₛ core-level spectra of the nanoplates and nanoflowers (FIG. 5C). The O₁ₛ core-level binding energy of the nanoplates was slightly lower than that of the nanoflowers. In addition, the O₁ₛ XPS pattern of the nanoflowers exhibited a shoulder at higher binding energy (approximately 535 eV). These findings are consistent with the identification of the nanoplates as maghemite and the nanoflowers as magnetite.

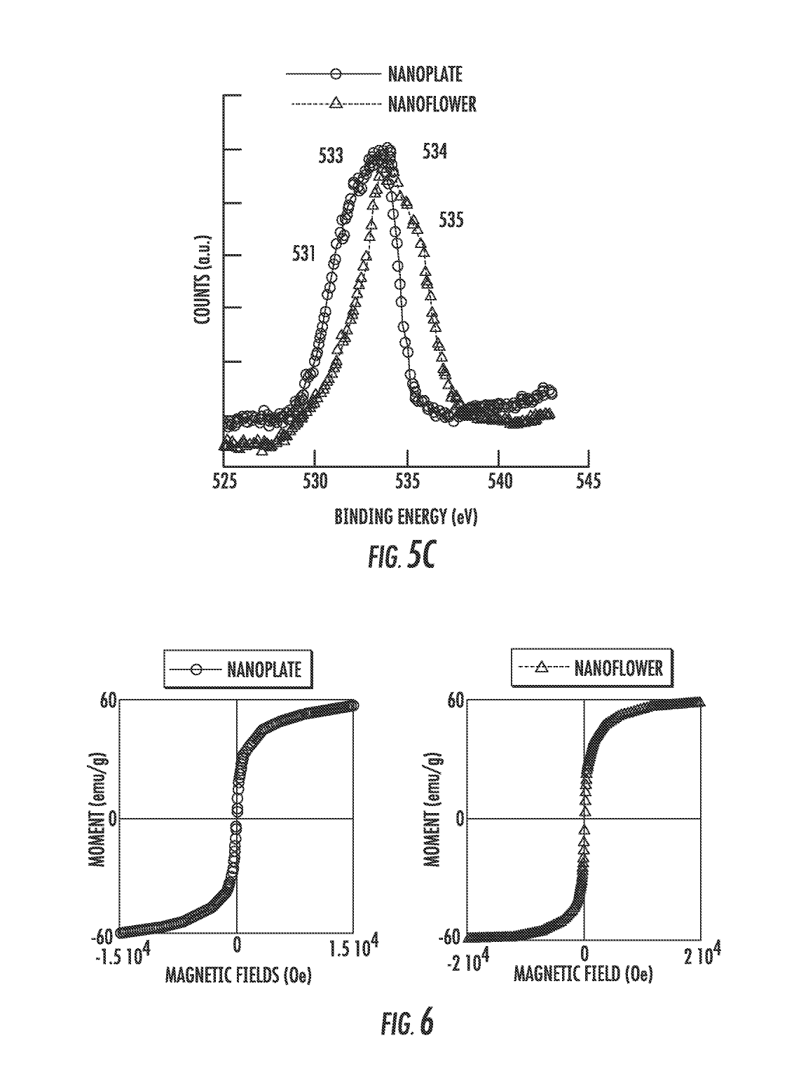

The magnetization versus applied field (M-H) curves of both nanoplates and nanoflowers showed large saturation fields (>1.5 Tesla), similar to that observed in small (<5 nm) spherical NPs (FIG. 6). The high saturation magnetic fields are consistent with the large surface areas of the nanostructures. The high thin morphology (˜3 nm) of the nanoplates and the small crystalline grains (˜5 nm) of the nanoflowers result in nanostructures having large surface areas. The presence of capping molecules and the magnetically disordered spin of atoms on the NP surface result in an increased paramagnetic signal as surface area of the NPs increases.

### Example 3

### Surface Functionalization of Iron Oxide Nanoparticles

A ligand-exchange method was used to functionalize the surface of iron oxide nanoparticles. This approach employed a ligand with low affinity for the NP surface (e.g., TOPO) as a co-capping molecule during synthesis. The introduction of TOPO molecules facilitates subsequent surface functionalization. The weak binding affinity and the bulky C8 tails of the TOPO molecule create preferred sites (termed “naked” spots) on the NP surface for hydrophilic ligands to attach, fostering an efficient ligand exchange process.

Dopamine, a molecule containing a catechol moiety and an amine moiety, was used as a capping ligand for the iron oxide nanoparticles. Dopamine was selected because it contained a first moiety that could interact with the NP surface with a greater affinity than the TOPO molecule, and a second moiety that provided a convenient synthetic handle for further covalent modification of the NP surface. The dopamine was exchanged onto the NP surface such that the amino group of dopamine interacts with the iron oxide nanoparticle, while the catechol group is presented on the particle surface. As a consequence, the catechol moiety was available to participate in subsequent coupling reactions to covalently functionalize the surface of the nanoparticles. This eliminates the use of chemical linkers and specialized conditions for chemical conjugation, thus providing a generalized route for attaching biological molecules and other nanostructures to iron oxide nanoparticle surfaces.

Dopamine Attachment onto Iron Oxide Nanoparticles

Iron oxide nanoparticles were synthesized using a modified heat-up method, similar to the method described above. A weak binding ligand, trioctylphospine oxide, was added during synthesis. The iron oleate complex (2.5 g, 2.8 mmol) was heated up to 320° C. in 1-octadecene (10 mL) in the presence of TOPO/OA (TOPO—0.2 g, 0.5 mmol; OA—0.22 mL, 0.7 mmol). After 2.5 hours, the reaction mixture was cooled down to room temperature, and the as—synthesized nanoparticles were precipitated out of solution by centrifugation and then dried under vacuum overnight.

The well-dried powder was then redispersed into chloroform under sonication to obtain a NP stock solution having a concentration of 5 mg NP/mL. 1 mL of the NP stock solution was mixed with dopamine·HCl (1.7 mg) in 49 mL of dimethysulfate oxide (DMSO). After 48 hours mixing at room temperature, the iron oxide nanoparticles were collected by centrifugation and re-dispersed in water (1 mg/mL).

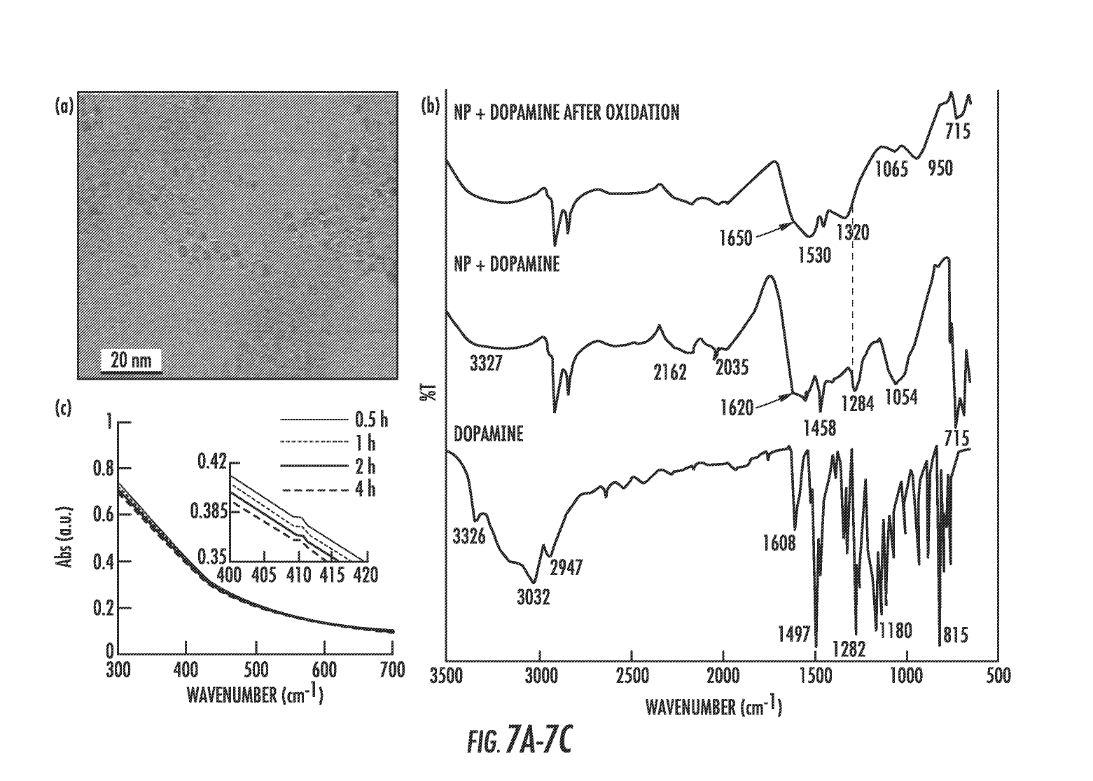

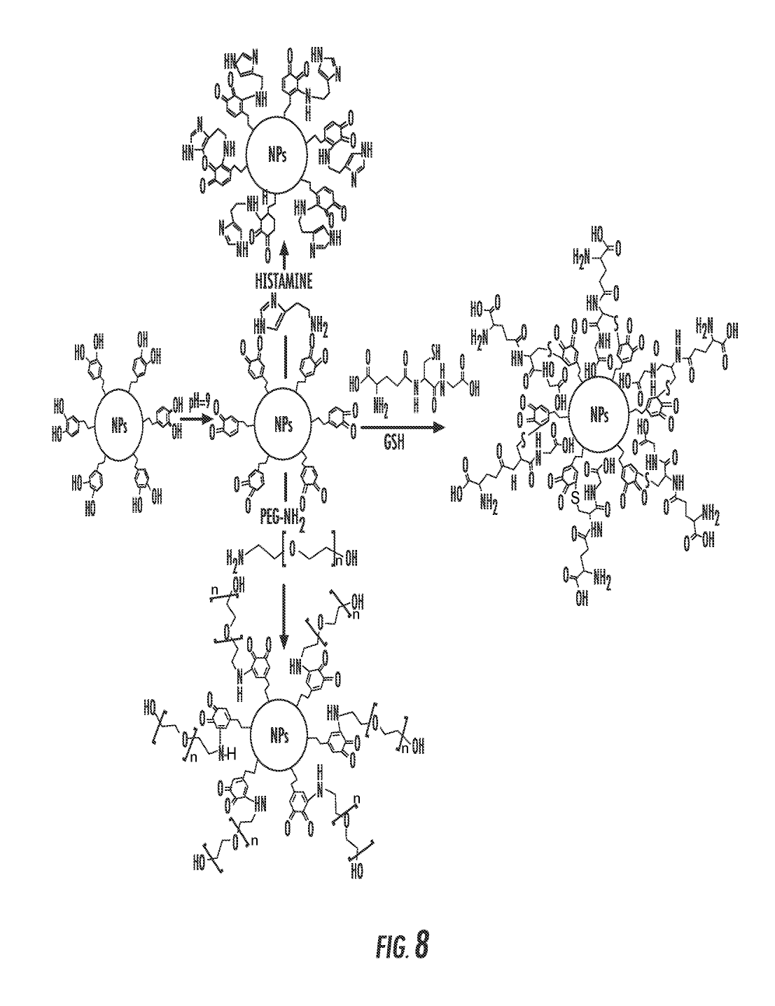

FIG. 7A shows a TEM image of the well-dispersed dopamine-coated, 10 nm iron oxide nanoparticles in water. The interaction between dopamine and the iron oxide nanoparticles was studied using Fourier transform infrared spectroscopy (FTIR) (FIG. 7B). Compared to that of the free dopamine, the FTIR spectrum of dopamine-coated nanoparticles showed several band shifts related to the primary amine group. The two —NH₂ stretching peaks of the free dopamine in the range of 3200-3400 cm⁻¹ became a single broad peak at 3327 cm⁻¹ after interacting with iron oxide nanoparticles. This broad peak is likely merged with the hydroxyl stretching in the similar region. After interacting with iron oxide nanoparticles, the dopamine —NH₂ bending (1577 and 1469 cm⁻¹) merged together with the —C═C— stretching in the range of 1460-1617 cm⁻¹ and a much broader peak was observed. Further, the band of the —NH₂ wagging (815 cm⁻¹) shifted to a lower wavelength, another indicator of the attachment of amino groups to the nanoparticle surfaces.

The FTIR spectra confirmed that the dopamine ligands were attached to the NP surface via their amine moieties, leaving the catechol moieties arrayed towards the solution. The presence of un-coordinated catechol groups on the nanoparticle exterior was also supported by the negative zeta-potential (−42 mV) of the dopamine-coated nanoparticles. If the amino moieties of the dopamine ligands were un-coordinated and present on the nanoparticle exterior, one would expect to observe a positive zeta-potential. The characteristic band of the —C—O stretching (1282 cm⁻¹) was unchanged before and after the attachment.

Surface Activation of Dopamine-Coated Iron Oxide Nanoparticles

The catechol moieties on the nanoparticle exterior were oxidized to quinone moieties at higher pH (>9) to form an active surface for further conjugation. The pH of nanoparticle solution above was adjusted to 9 with NaOH (1M) to activate the dopamine coatings. The nanoparticle solution was then sonicated for 10 min to accelerate the activation process and kept at room temperature.

The IR spectrum of the activated nanoparticles is shown in FIG. 7B. The appearance of the broad band at 1650 cm⁻¹ is the characteristic of —C═O band in quinone structure. The disappearance of the characteristic band of —C—O at 1282 cm⁻¹ is also consistent with dopamine oxidation. The oxidation process was also monitored with UV-vis spectroscopy (FIG. 7C). Because of the strong absorption of iron oxide nanoparticles, the absorption of the oxidized dopamine molecules was not well resolved. However, the typical absorption peak (409 nm) of the oxidized dopamine was clearly visible in the detailed scan (FIG. 7C—insert). This absorption matched well with spectra measured for oxidized free dopamine Both the FTIR and the UV-vis spectra confirmed the dopamine oxidation on the iron oxide nanoparticle surfaces. The activated catechol moieties can be used for the direct conjugation of molecules, including biological molecules, to the iron oxide nanoparticles through, for example, a Michael addition and/or Schiff base formation.

Surface Functionalization of Iron Oxide Nanoparticles

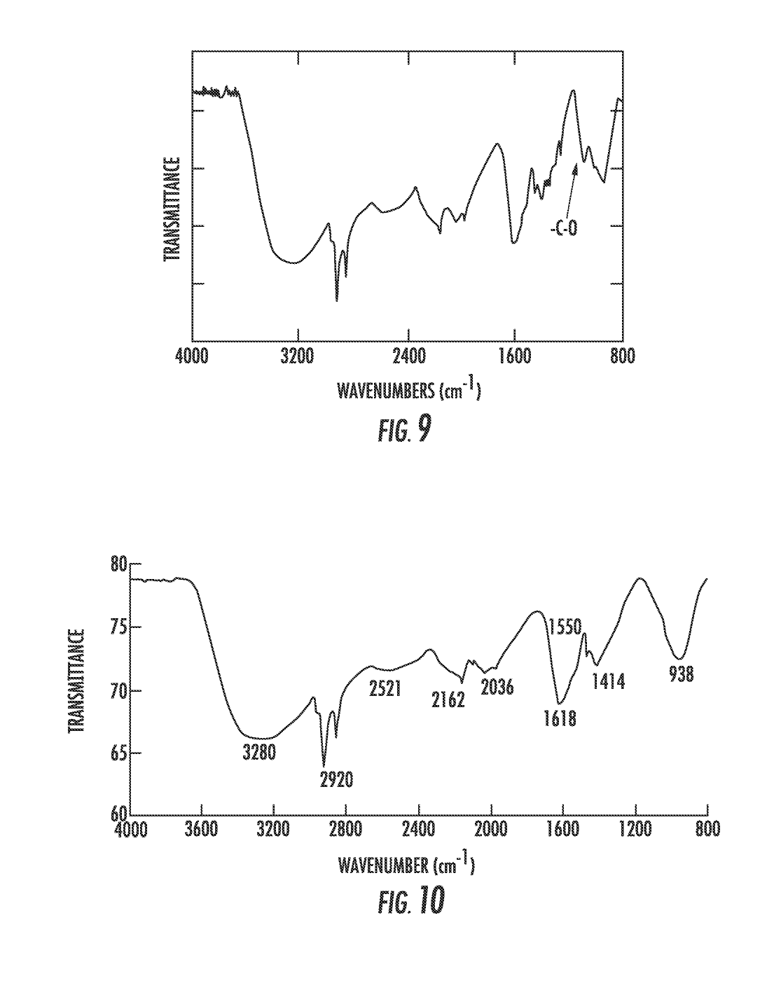

A general scheme for conjugation and NP functionalization is shown in FIG. 8. As shown in FIG. 8, the NP surface includes dopamine ligands, which are coordinated to the NP surface via their amine moieties. The catechol moieties of the dopamine ligands remain un-coordinated, and are extended towards solution. In the first step, the catechol moieties are activated by oxidation to form quinone moieties. In the second step, the quinone moieties can be reacted with a suitable nucleophile to covalently functionalize the surface of the nanoparticles.

To activate the dopamine-coated NPs for conjugation with other molecules, the pH of nanoparticle solution was adjusted to 9 with NaOH (1M) to activate the dopamine coatings as described above. The nanoparticle solution was sonicated for 10 minutes at room temperature to accelerate the activation process. After 4 hours, the nanoparticles were reacted with suitable nucleophiles to functionalize the NP surface. Surface functionalization was verified by FTIR. The hydrodynamic size and zeta potential of the functionalized NPs was also studied using dynamic light scattering (DLS).

Attachment of Amine-Terminated PEG Molecules to Iron Oxide NPs

After 4 hours activation as described above, the activated NPs were reacted with an excess of amine-terminated polyethylene glycol (PEG). FIG. 9 shows FTIR spectrum of the PEG conjugated iron oxide NPs. The —C—O stretch around 1028 cm⁻¹ was clearly seen in the FTIR spectrum, indicating the successful conjugation. Conjugation of the PEG molecules to the NP surface increased the water solubility of the NPs.

Attachment of Glutathione to Iron Oxide NPs

After 4 hours activation as described above, the activated NPs were reacted with an excess of glutathione. Glutathione is a tripeptide which contains both a thiol group and an amino group. Both of these groups could potentially react with the activated catechol moieties present on the exterior of the NPs; however, one would expect preferential reaction via the thiol group of glutathione.

FIG. 10 shows the FTIR spectra of the glutathione-conjugated nanoparticles. The peak at 1550 cm⁻¹ indicated the presence of amino groups on the nanoparticle surface. The peak at 938 cm⁻¹ was assigned to a —C—S bond. In combination with the small signal from free —SH groups (2521 cm⁻¹), the FTIR suggested possible conjugation via the amino groups of the glutathione rather than —SH groups for a small portion of glutathione molecules.

Attachment of a Small Molecule to Iron Oxide NPs

Histamine is an organic compound which is present in human body, and is involved in several biological activities, including local immune responses and inflammatory responses. Histamine contains a primary group, permitting direct conjugation onto activated iron oxide NP surfaces.

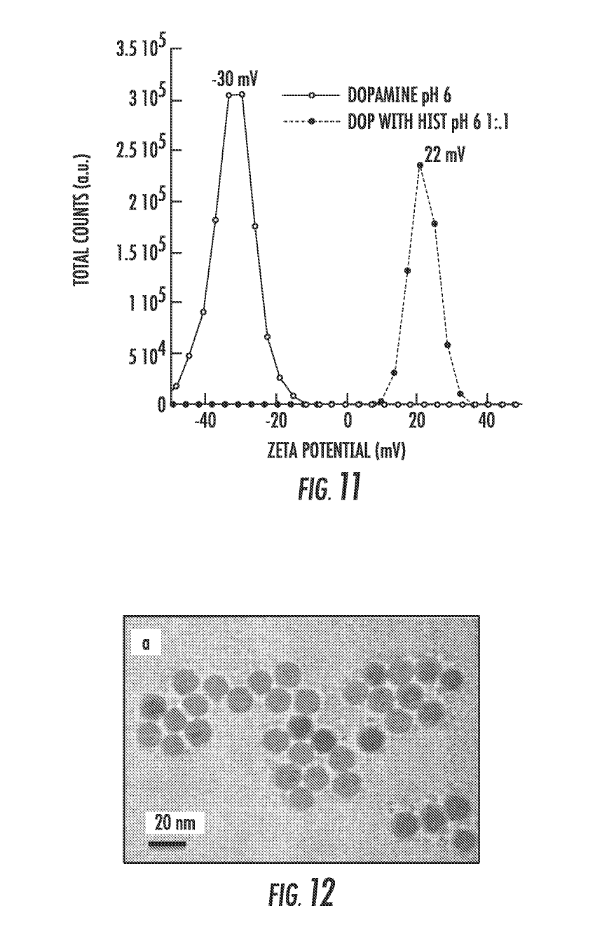

After 4 hours activation as described above, the activated NPs were reacted with an excess of histamine. FIG. 11 shows the zeta potential measurements of the nanoparticles before and after conjugation with histamine. As shown in FIG. 11, prior to histamine conjugated, the activated NPs displace a net negative surface charge at pH 6. Upon reaction histamine, the NPs display a net positive surface charge. This finding was consistent with successful conjugation of histamine to the NP surface.

Attachment of an Antibody to Iron Oxide NPs

The ability to successfully conjugate proteins, such as antibodies, to the surface of NPs is important for many potential biomedical applications (e.g., for NP targeting and/or therapeutic purposes). To investigate the suitability of these methods to conjugate proteins, such as antibodies, to the NP surface, the activated iron oxide NPs were reacted with IgG antibody.

After 4 hours activation as described above, the activated NPs were reacted with an excess of IgG antibody. FIG. 12 shows the negative stained TEM image of the IgG antibody-conjugated nanoparticles. The lighter shell visible around the nanoparticles was indicative of the presence of IgG antibodies conjugated to the NP surface. Depending on the orientation of the antibody, the shell region can vary in size.

Attachment of an Inorganic Nanostructure Capped with Biomolecules to Iron Oxide NPs

This conjugation strategy was also applied to attach inorganic nanomaterials to the surface of the iron oxide NPs.

Fluorescent gold nanoclusters coated with bovine serum albumin (BSA) were synthesized using methods known in the art. Specifically, BSA powder (50 mg) was dissolved in water (1 mL, 18.2Ω). Cold HAuCl₄ solution (0.2 wt %, 3.4 mL) was added to the BSA solution, and the resulting mixture was reacted at room temperature for an hour, allowing for complexation between BSA and Au ions. Finally, NaOH (0.5 mL, 1M) was added into this mixture to trigger the reduction of Au ions, and subsequent formation of Au nanoclusters. The mixture was then reacted at 45° C. After 4 hours, the yellowish Au nanocluster solution was collected.

The BSA-coated gold nanoclusters were then conjugated to the activated dopamine-coated NPs described above. A solution of the activated NPs (0.5 mL, 1 mg/mL) was mixed with the as-synthesized BSA-Au nanocluster solution (4.9 mL), and reacted at room temperature. After 12 hours, the conjugated nanoparticles were magnetically separated from the solution, and re-dispersed in water. The magnetic separation was performed by placing a permanent magnet next to the sample vial for half an hour. The solution was removed with disposal pipettes, leaving the conjugated NPs behind in the vial as a solid. To ensure the removal of any un-conjugated gold nanoclusters, this process was repeated twice.

The morphology and size of iron oxide nanoparticles were examined under bright field TEM. The gold nanocluster attachment was confirmed with HAADF imaging. The surface chemistry of the nanoparticles was studied by FTIR spectroscopy. The hydrodynamic size and surface charge of the nanoparticles in aqueous solution was measured using a Zetasizer nano series dynamic light scattering (DLS) instrument. The fluorescence of BSA-encapsulated Au nanoclusters and conjugated nanoparticles were studied using a Cary Eclipse fluorescence spectrophotometer. The UV-vis spectra were collected on a Shimadzu UV-visible spectrophotometer (UV-1700 series). The magnetic moment versus applied magnetic field (M-H) curves were measured using an alternating gradient magnetometer (AGM). The quantum yields of the BSA-Au nanoclusters and the integrated nanoparticles were calculated by comparing the wavelength-integrated fluorescence intensities of the samples to that of a standard fluorescent dye with known quantum yield.

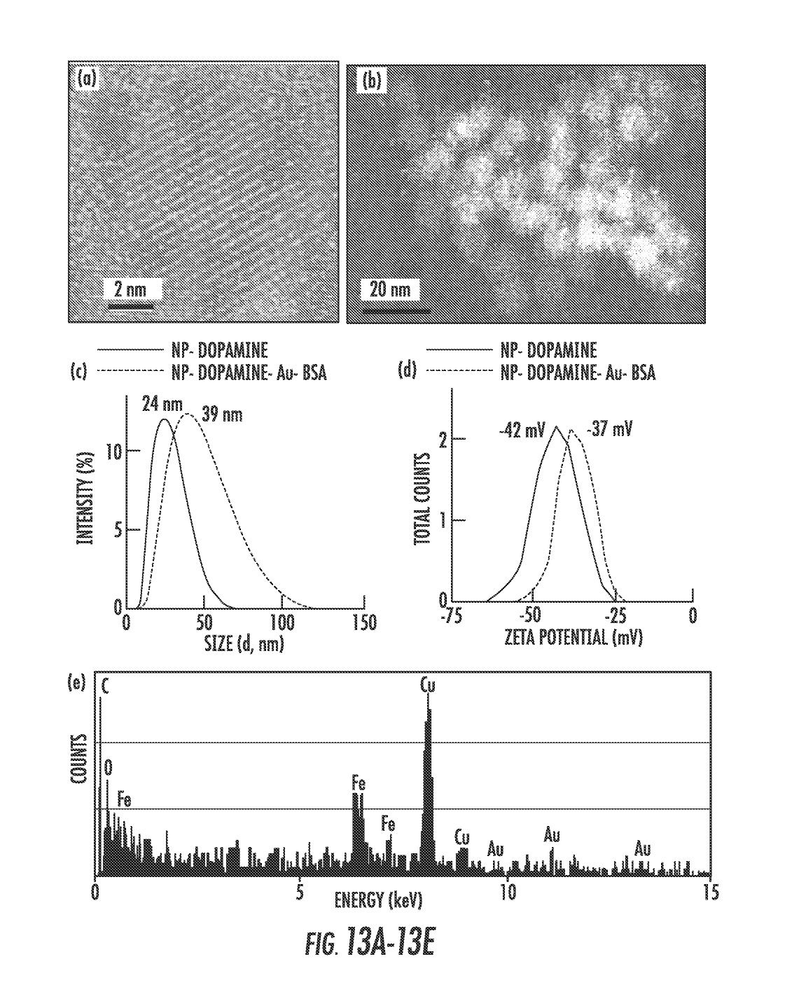

FIG. 13A shows a HRTEM image of a BSA-coated Au nanocluster conjugated to an iron oxide nanoparticle. The Au nanoclusters-NP conjugates were also evaluated by high angle annular dark field (HAADF) scanning transmission electron microscopy (FIG. 13B). Similar to the HRTEM observation, the HAADF image suggested that one Au nanocluster was likely conjugated onto each iron oxide nanoparticle.

The conjugation of BSA-Au nanoclusters to the iron oxide NPs yielded a hydrodynamic size increase (24 to 39 nm) as shown in FIG. 13C. The extended tail of the DLS plot was likely from the undefined shape and size of the denatured BSA protein, because the Au nanoclusters were synthesized at very high pH (˜12). The covalent conjugation of BSA-Au nanoclusters also shifted the negative zeta potential of the dopamine-coated nanoparticles from −42 to −37 mV (FIG. 13D). Both the DLS plots and zeta-potential measurements also support the successful conjugation of the nanoclusters to the iron oxide nanoparticle surfaces. The EDX spectrum collected from a group of the NPs also showed the presence of both Fe and Au elements, further confirming successful conjugation (FIG. 13E).

Attachment of Lysine to Iron Oxide NPs

Lysine is a basic essential amino acid, and an important amino acid for protein water solubility. Lysine's corresponding polymer, poly(lysine), is a common surface treatment molecule for many biological surfaces. Lysine contains two amine groups: a first amine on the amino acid side chain and a second amine connected to the alpha carbon of the amino acid. These primary amine groups permit direct conjugation onto activated iron oxide NP surfaces.

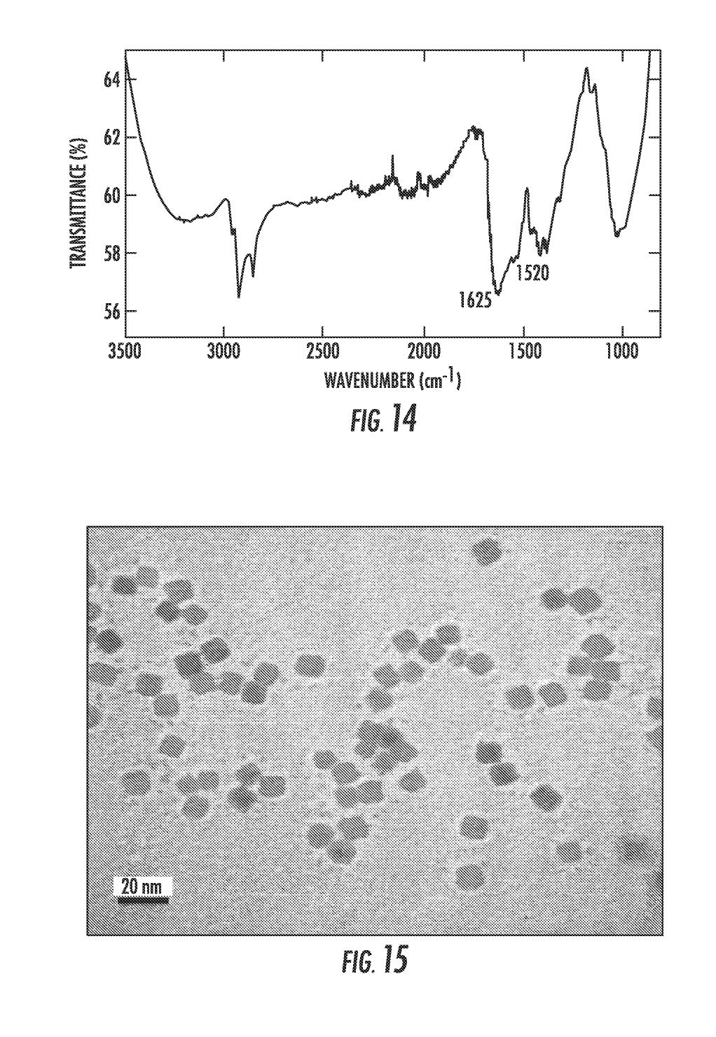

After 4 hours activation as described above, the activated NPs were reacted with an excess of lysine. FIG. 14 shows the FTIR spectrum of the resulting lysine-conjugated iron oxide nanoparticles. The strong primary amine (—N—H) band at 1625 cm⁻¹ is consistent with successful conjugation of lysine molecules to the nanoparticle surfaces.

Attachment of an Antibody to Non-Spherical Iron Oxide NPs

The ability to successfully conjugate proteins, such as antibodies, to the surface of spherical NPs was demonstrated above. The same methods were used to conjugate a representative antibody to the surface of iron oxide nanocubes. Specifically, dopamine was conjugated onto the surface of cubic shape iron oxide nanoparticles using the methods described above. After 4 hours activation as described in other examples, the activated nanocubes were reacted with an excess of IgG antibody.

FIG. 15 shows a negative stained TEM image of the IgG antibody-conjugated nanocubes. The lighter shell visible around the nanoparticles was indicative of the presence of IgG antibodies conjugated to the NP surface. Depending on the orientation of the antibody, the shell region can vary in size. This conjugation indicates that the surface functionalization method described herein can be extended to other shaped nanoparticles.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A method of preparing non-spherical nanoparticles comprising
a) incubating a precursor complex comprising a metallic moiety and one or more ligands coordinated to the metallic moiety at a temperature of from about 100° C. to about 300 ° C. for a period of time effective to form a population of nuclei by thermal displacement of one or more of the ligands from the metallic moiety, and
b) heating the nuclei at a temperature of from greater than 300° C. to about 400° C. to form a population of non-spherical nanoparticles,
wherein the smallest dimension of the non-spherical nanoparticles is greater than 4 nm.

2. The method of claim 1, wherein the smallest dimension of the non-spherical nanoparticles ranges from greater than 4 nm to about 50 nm.

3. The method of claim 1, wherein the non-spherical nanoparticles comprise nanocubes, nanobars, or combinations thereof.

4. The method of claim 1, wherein the metallic moiety comprises Fe²⁺, Fe³⁺, a ferric oxide, ferrous oxide, a non-ferrous metal ion, a non-ferrous metal ferrite, or combinations thereof.

5. The method of claim 4, wherein the non-ferrous metal ion comprises Zn²⁺, Ca²⁺, Mg²⁺, Mn²⁺, Cu²⁺, Co²⁺, Cr²⁺, Ni²⁺, Na⁺, K⁺, Ba²⁺, or combinations thereof.

6. The method of claim 4, wherein the non-ferrous metal ferrite comprises a zinc ferrite, a calcium ferrite, a magnesium ferrite, a manganese ferrite, a copper ferrite, a chromium ferrite, a cobalt ferrite, a nickel ferrite, a sodium ferrite, a potassium ferrite, a barium ferrite, or combinations thereof.

7. The method of claim 1, wherein the one or more ligands comprise a fatty acid, a capping ligand, or a combination thereof.

8. The method of claim 7, wherein the fatty acid comprises myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, caprylic acid, capric acid, lauric acid, myristic acid, palmitic acid, stearic acid, arachidic acid, behenic acid, lignoceric acid, cerotic acid, eicosenoic acid, mead acid, nervonic acid, or combinations thereof.

9. The method of claim 7, wherein the capping ligand comprises a phosphine, a phosphine oxide, an amine, a thiol, a siloxane, or combinations thereof.

10. The method of claim 1, wherein the precursor complex is incubated at a temperature of from about 200° C. to about 300° C.

11. The method of claim 1, wherein the nuclei are heated at a temperature of from greater than 300° C. to about 350° C.

12. The method of claim 1, further comprising incubating the precursor complex at a temperature of from about 60° C. to about 100° C. for a period of time effective to remove residual solvents from the precursor complex.

13. A method of preparing non-spherical nanoparticles comprising
a) incubating a precursor complex comprising a metallic moiety and one or more ligands coordinated to the metallic moiety at a temperature of from about 100° C. to about 300 ° C. for a period of time effective to form a population of non-spherical nanoparticles by thermal displacement of one or more of the ligands from the metallic moiety, and
b) adding a ligand mixture comprising one or more fatty acids and one or more capping ligands, wherein the molar ratio of the fatty acids to the capping ligands ranges from 2:1 to 1:10.

14. The method of claim 13, wherein the molar ratio of the fatty acids to the capping ligands ranges from 1:1 to 1:5.

15. The method of claim 13, wherein the smallest dimension of the non-spherical nanoparticles ranges from greater than 3 nm to about 50 nm.

16. The method of claim 13, wherein the non-spherical nanoparticles comprise nanocubes, nanobars, nanoplates, nanoflowers, or combinations thereof.

17. The method of claim 13, wherein the metallic moiety comprises Fe²⁺, Fe³⁺, a ferric oxide, ferrous oxide, a non-ferrous metal ion, a non-ferrous metal ferrite, or combinations thereof.

18. The method of claim 17, wherein the non-ferrous metal ion comprises Zn²⁺, Ca²⁺, Mg²⁺, Mn²⁺, Cu²⁺, Co²⁺, Cr²⁺, Ni²⁺, Na⁺, K⁺, Ba²⁺, or combinations thereof.

19. The method of claim 17, wherein the non-ferrous metal ferrite comprises a zinc ferrite, a calcium ferrite, a magnesium ferrite, a manganese ferrite, a copper ferrite, a chromium ferrite, a cobalt ferrite, a nickel ferrite, a sodium ferrite, a potassium ferrite, barium ferrite, or combinations thereof.

20. The method of claim 13, wherein the fatty acid comprises myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, caprylic acid, capric acid, lauric acid, myristic acid, palmitic acid, stearic acid, arachidic acid, behenic acid, lignoceric acid, cerotic acid, eicosenoic acid, mead acid, nervonic acid, or combinations thereof.

21. The method of claim 13, wherein the capping ligand comprises a phosphine, a phosphine oxide, an amine, a thiol, a siloxane, or combinations thereof.

22. The method of claim 13, wherein fatty acid comprises oleic acid and the capping ligand comprises a trialkylphosphine oxide.
